(19) United States
(12) Patent Application Publication
(10) Pub. No.: US 2011/0164508 A1
(43) Pub. Date: Jul. 7, 2011

(54) NETWORK RELAY APPARATUS, NETWORK SYSTEM, AND CONTROL METHOD OF NETWORK RELAY APPARATUS

(75) Inventors: MASAYA ARAI, Atsugi (JP); Keiichirou Yamate, Hadano (JP); Shinji Nozaki, Kawasaki (JP)

(73) Assignee: ALAXALA Networks Corporation

(21) Appl. No.: 12/984,266

(22) Filed: Jan. 4, 2011

(30) Foreign Application Priority Data
Jan. 7, 2010 (JP) 2010-001669

(51) Int. Cl. H04L 12/26; H04L 12/56

(52) U.S. Cl. 370/245; 370/401

(57) ABSTRACT

Network relay apparatus connected directly or indirectly to a first processing apparatus, a second processing apparatus, and a client apparatus, the network relay apparatus being configured to relay packet communication between the respective apparatuses, wherein one identical address is set in both the first processing apparatus and the second processing apparatus, and the client apparatus uses the first processing apparatus and the second processing apparatus. The network relay apparatus includes: a first route information storage configured to store route information of a first virtual network to which the first processing apparatus belongs; a second route information storage configured to store route information of a second virtual network to which the second processing apparatus belongs; a route information advertiser configured to receive advertisement for route information on the first virtual network and store the received route information into the first route information storage, a state detector; and a packet forwarding processor.

### CROSS-REFERENCE TO RELATED APPLICATIONS

The present application claims priority to Japanese Patent Application No. 2010-1669 filed on Jan. 7, 2010, the disclosure of which is hereby incorporated by reference in its entirety.

### BACKGROUND OF THE INVENTION

1. Field of the Invention

The present invention relates to a network relay apparatus.

2. Description of the Related Art

One conventionally known method for establishing a network system with high reliability and high availability is MPLS (Multi-Protocol Label Switching)-based Fast Reroute (FRR) technology. The MPLS-based FRR technology sets in advance a primary LSP (Label Switched Path) and a backup LSP for each of routers included in the network system. On the occurrence of a failure at a node or in a line on the primary LSP, each router changes over the communication path from the primary LSP to the backup LSP. The MPLS-based FRR technology does not require route recalculation of the routing protocol on the occurrence of a failure by setting in advance the primary LSP and the backup LSP.

Another conventionally known method for establishing a network system with high reliability and high availability is IP-FRR (Internet Protocol Fast Resource) technology without using the MPLS functions. The IP-FRR technology computes a backup route in advance in case of the occurrence of a failure in a line or at a node in the network system, in order to allow for a quick changeover of the communication path to the computed backup route on the occurrence of a failure.

The conventional MPLS-based FRR technology requires all the routers included in the network system to be MPLS-compatible. This undesirably increases the manufacturing cost of the network system. The conventional MPLS-based FRR technology also requires knowledge for management of the MPLS network. This undesirably increases the operation cost of the network system. The conventional IP-FRR technology, on the other hand, increases the computational load of the routing protocol for computing the backup route in proportion to an increase in number of adjacent routers and further has restrictions on conditions for computing the backup route in advance.

### SUMMARY

By taking into account the issue discussed above, there is a requirement for providing a network system with high reliability and high availability that has the computational cost of a routing protocol for computing a backup route substantially equivalent to the computational cost of the conventional routing protocol without requiring MPLS functions.

According to first aspect of the present invention, a network relay apparatus is provided. The network relay apparatus connected directly or indirectly to a first processing apparatus, a second processing apparatus, and a client apparatus, the network relay apparatus being configured to relay packet communication between the respective apparatuses, wherein one identical address is set in both the first processing apparatus and the second processing apparatus, and the client apparatus uses the first processing apparatus and the second processing apparatus, the network relay apparatus includes: a first route information storage configured to store route information of a first virtual network to which the first processing apparatus belongs; a second route information storage configured to store route information of a second virtual network to which the second processing apparatus belongs; a route information advertiser configured to receive advertisement for route information on the first virtual network and store the received route information into the first route information storage, while receiving advertisement for route information on the second virtual network and storing the received route information into the second route information storage; a state detector configured to detect a state of the first virtual network and a state of the second virtual network; and a packet forwarding processor configured to forward a packet, which is received from the client apparatus and has the identical address as a destination, to the first processing apparatus or the second processing apparatus, based on route information of one of the first and second virtual networks specified according to the detected states of the first and second virtual networks.

The network relay apparatus according to this aspect of the invention has the storage of the route information of the first virtual network and the route information of the second virtual network. The packet forwarding processor forwards a received packet to the first processing apparatus or the second processing apparatus, based on the route information of one of the first and second virtual networks specified according to the states of the first and second virtual networks, e.g., the occurrence or non-occurrence of a failure on a route. This arrangement provides the network system with high reliability and high availability that has the computational cost of a routing protocol for computing a backup route substantially equivalent to the computational cost of the conventional routing protocol without requiring MPLS functions.

According to the first aspect of the present invention, the state detector may include: a first state detector configured to detect a failure on a route in the first virtual network; and a second state detector configured to detect a failure on a route in the second virtual network, the network relay apparatus may further include: a VRF definition information storage configured to store VRF definition information for defining which of the first virtual network and the second virtual network each of interfaces respectively connected to the first processing apparatus, the second processing apparatus, and the client apparatus belongs to, and a failover processor configured to update at least one of the route information and the VRF definition information, based on occurrence or non-occurrence of a failure detected by the first state detector or the second state detector, wherein on reception of a packet, the packet forwarding processor may identify a virtual network to which a packet input interface of receiving the packet belongs according to the VRF definition information, search a route based on route information on the identified virtual network, and forward the received packet via the searched route.

In the network relay apparatus of this aspect, the failover processor updates at least one of the route information and the VRF definition information, based on the occurrence or non-occurrence of a failure detected by the first state detector or the second state detector. This arrangement enables the failover process (to change over the communication route to the backup route) to be performed within a short time.

According to the first aspect of the present invention, the VRF definition information may define in advance that the interface connected to the first processing apparatus and the interface connected to the client apparatus belong to the first virtual network, and the interface connected to the second processing apparatus belongs to the second virtual network, and on detection of a failure by the first state detector, the failover processor may update the VRF definition information to change over membership of the interface connected to the client apparatus to the second virtual network.

In the network relay apparatus of this aspect, on detection of a failure on the route in the first virtual network by the first state detector, the failover processor updates the VRF definition information to change over the membership of the client apparatus from the first virtual network to the second virtual network. Even on the occurrence of a failure on the route in the first virtual network, this arrangement enables the failover process (to change over the communication route to the backup server) to be performed within a short time by simply updating the VRF definition information.

According to the first aspect of the present invention, on reception of a packet, the packet forwarding processor may compare the virtual network to which the packet input interface belongs with a virtual network to which a packet output interface connected to an apparatus as a destination of the received packet belongs, and when the virtual networks match each other, the packet forwarding processor may forward the received packet, when the virtual networks do not match each other, discarding the received packet without forwarding.

In the network relay apparatus of this aspect, when the virtual network to which a packet source apparatus belongs is different from the virtual network to which a packet destination apparatus belongs, the packet forwarding processor discards the received packet without forwarding. This arrangement restricts communication between apparatuses belonging to different virtual networks, thus enhancing the safety in the network system.

According to second aspect of the present invention, a network system is provided. The network system includes: a first processing apparatus arranged to belong to a first virtual network; a second processing apparatus arranged to belong to a second virtual network; a client apparatus configured to use the first processing apparatus or the second processing apparatus; and a network relay apparatus connected directly or indirectly to the first processing apparatus, the second processing apparatus, and the client apparatus and configured to relay packet communication between the respective apparatuses, wherein the first processing apparatus and the second processing apparatus have one identical address, and the network relay apparatus includes: a first route information storage configured to store route information of the first virtual network; a second route information storage configured to store route information of the second virtual network; a route information advertiser configured to receive advertisement for route information on the first virtual network and store the received route information into the first route information storage, while receiving advertisement for route information on the second virtual network and storing the received route information into the second route information storage; a state detector configured to detect a state of the first virtual network and a state of the second virtual network; and a packet forwarding processor configured to forward a packet, which is received from the client apparatus and has the identical address as a destination, to the first processing apparatus or the second processing apparatus, based on route information of one of the first and second virtual networks specified according to the detected states of the first and second virtual networks.

The network system according to this aspect of the invention has the similar effects to those of the network relay apparatus described above.

According to third aspect of the present invention, a control method for a network relay apparatus is provided. The network relay apparatus being connected directly or indirectly to a first processing apparatus, a second processing apparatus, and a client apparatus, the network relay apparatus being configured to relay packet communication between the respective apparatuses, wherein one identical address is set in both the first processing apparatus and the second processing apparatus, and the client apparatus uses the first processing apparatus and the second processing apparatus, the control method includes the steps of: (a) receiving advertisement for route information on the first virtual network to which the first processing apparatus belongs and storing the received route information; (b) receiving advertisement for route information on the second virtual network to which the second processing apparatus belongs and storing the received route information; (c) detecting a state of the first virtual network and a state of the second virtual network; and (d) forwarding a packet, which is received from the client apparatus and has the identical address as a destination, to the first processing apparatus or the second processing apparatus, based on route information of one of the first and second virtual networks specified according to the detected states of the first and second virtual networks.

The control method according to this aspect of the invention has the similar effects to those of the network relay apparatus described above.

According to fourth aspect of the present invention, a network system is provided. The network system includes: a second network relay apparatus connected to a client apparatus using the processing apparatus, wherein a first interface of the first network relay apparatus and a first interface of the second network relay apparatus connect with each other directly or indirectly via another network to establish a first virtual network, and a second interface of the first network relay apparatus and a second interface of the second network relay apparatus connect with each other directly or indirectly via another network to establish a second virtual network, each of the first network relay apparatus and the second network relay apparatus comprising: a first route information storage configured to store route information of the first virtual network; a second route information storage configured to store route information of the second virtual network; a route information advertiser configured to receive advertisement for route information on the first virtual network and store the received route information into the first route information storage, while receiving advertisement for route information on the second virtual network and storing the received route information into the second route information storage; and a packet forwarding processor configured to forward a received packet to a packet destination apparatus, based on route information of one of the first and second virtual networks specified according to states of the first and second virtual networks.

In the network system according to this aspect of the invention, the first interface of the first network relay apparatus and the first interface of the second network relay apparatus connect with each other directly or indirectly via another network to establish the first virtual network. The second interface of the first network relay apparatus and the second interface of the second network relay apparatus connect with each other directly or indirectly via another network to establish the second virtual network. Namely there are redundant communication routes between the processing apparatus and the client apparatus. The packet forwarding processor uses the route information of one of the first and second virtual networks specified according to the states of the first virtual network and the second virtual network (for example, the occurrence or non-occurrence of a failure on the route) to forward a received packet to a packet destination apparatus. This arrangement has the similar effects to those of the network relay apparatus described above.

According to the fourth aspect of the present invention, the first network relay apparatus may further include a VRF definition information storage configured to store VRF definition information for defining which of the first virtual network and the second virtual network the processing apparatus belongs to, the second network relay apparatus may further include a VRF definition information storage configured to store VRF definition information for defining which of the first virtual network and the second virtual network the client apparatus belongs to, on reception of a packet, the packet forwarding processor of the first network relay apparatus or the packet forwarding processor of the second network relay apparatus may compare a virtual network to which a packet input interface of receiving the packet belongs with a virtual network to which a packet output interface connected to an apparatus as a destination of the received packet belongs, and forward the received packet, irrespective of matching or mismatching of the virtual networks.

In the network system of this aspect, the packet forwarding processor forwards a received packet, even when the virtual network to which the packet source apparatus belongs is different from the virtual network to which the packet destination apparatus belongs. This characteristic enables packets to be forwarded by different routes for an upload path and for a download path. This arrangement enhances the flexibility of packet forwarding in the network system.

The technique of the invention is not restrictively actualized by the network relay apparatus having any of the configurations and arrangements discussed above, but may be actualized by diversity of other applications including a network relay method corresponding to the network relay apparatus, a computer program configured to attain the functions of such a device or a method, as well as a recording medium with such a computer program recorded therein.

### BRIEF DESCRIPTION OF THE DRAWINGS

FIG. 1 is an explanatory diagrammatic representation of the general configuration of a network system according to a first embodiment of the invention;

FIG. 2 is an explanatory diagrammatic representation of one example of IP address information on the two servers;

FIG. 3 is an explanatory diagrammatic representation of one example of IP address information on the host;

FIG. 4 is an explanatory diagrammatic representation of one example of setting information on the two routers;

FIG. 5 is an explanatory diagrammatic representation of one example of configuration information used for defining the configuration of the network apparatus;

FIG. 6 is an explanatory diagrammatic representation of one example of the settings in the interface database;

FIG. 7 is an explanatory diagrammatic representation of a processing flow for creating the VRF1 routing table and the VRF2 routing table;

FIG. 8 is an explanatory diagrammatic representation of one example of the settings in the VRF1 routing table based on the registries in the interface database of FIG. 6;

FIG. 9 is an explanatory diagrammatic representation of one example of the settings in the VRF2 routing table based on the registries in the interface database of FIG. 6;

FIG. 10 is an explanatory diagrammatic representation of a processing flow for advertising direct route information managed by the direct route controller according to the OSPF protocol;

FIG. 11 is an explanatory diagrammatic representation of the operations of the network system before the occurrence of a failure in an OSPF neighbor state with the router as a monitor object;

FIG. 12 is a flowchart showing a packet forwarding process performed in the network apparatus;

FIG. 13 is a flowchart showing a failover process;

FIG. 14 is an explanatory diagrammatic representation of the operations of the network system during the failover process;

FIG. 15 is an explanatory diagrammatic representation of the registries in the interface database after the update at step S505 in the failover process of FIG. 13;

FIG. 16 is an explanatory diagrammatic representation of the operations of the network system after the occurrence of a failure in the OSPF neighbor state with the router as the monitor object;

FIG. 17 is an explanatory diagrammatic representation of the general configuration of a network system according to the second embodiment;

FIG. 18 is an explanatory diagrammatic representation of one example of setting information on the router;

FIG. 19 is an explanatory diagrammatic representation of one example of configuration information used for defining the configuration of the network apparatus;

FIG. 20 is an explanatory diagrammatic representation of one example of the settings in an interface database included in the network apparatus;

FIG. 21 is an explanatory diagrammatic representation of a processing flow for creating a VRF1 routing table and a VRF2 routing table in the network apparatus;

FIG. 22 is an explanatory diagrammatic representation of one example of the settings in the VRF1 routing table of the network apparatus based on the registries in the interface database of FIG. 20;

FIG. 23 is an explanatory diagrammatic representation of one example of the settings in the VRF2 routing table of the network apparatus based on the registries in the interface database of FIG. 20;

FIG. 24 is an explanatory diagrammatic representation of a processing flow for advertising the mutual route information by the first OSPF processor, the second OSPF processor, and the third OSPF processor according to the OSPF protocol;

FIG. 25 is an explanatory diagrammatic representation of one example of configuration information used for defining the configuration of the network apparatus;

FIG. 26 is an explanatory diagrammatic representation of one example of the settings in an interface database included in the network apparatus;

FIG. 27 is an explanatory diagrammatic representation of one example of the settings in the VRF1 routing table of the network apparatus based on the registries in the interface database of FIG. 26;

FIG. 28 is an explanatory diagrammatic representation of one example of the settings in the VRF2 routing table of the network apparatus based on the registries in the interface database of FIG. 26;

FIG. 29 is an explanatory diagrammatic representation of the operations of the network system before the occurrence of a failure in an OSPF neighbor state of the network apparatus with the router in the network as a monitor object;

FIG. 30 is a flowchart showing a failover process performed in the second embodiment;

FIG. 31 is an explanatory diagrammatic representation of the operations of the network system during the failover process of the second embodiment;

FIG. 32 is an explanatory diagrammatic representation of the registries in the interface database of the network apparatus after the update at step S505 in the failover process of FIG. 30;

FIG. 33 is an explanatory diagrammatic representation of the operations of the network system after the occurrence of a failure in the OSPF neighbor state with the router in the network as the monitor object; and

FIG. 34 is an explanatory diagrammatic representation of a processing flow for advertising the mutual route information by the first OSPF processor, the second OSPF processor, and the third OSPF processor according to the OSPF protocol after the occurrence of a failure in the OSPF neighbor state with the router in the network as the monitor object.

### DESCRIPTION OF THE PREFERRED EMBODIMENT

Next, aspects of the present invention will be described in the following order on the basis of embodiments:

### A. First Embodiment

### (A-1) System Configuration

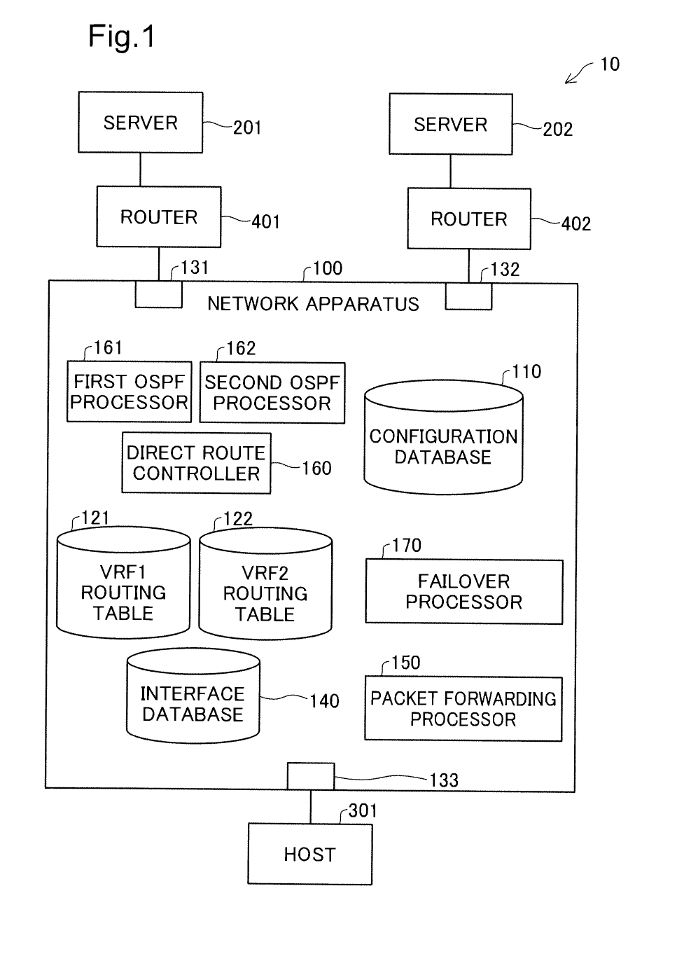

FIG. 1 is an explanatory diagrammatic representation of the general configuration of a network system 10 according to a first embodiment of the invention. The network system 10 includes two servers (a primary server 201 and a backup server 202), three layer 3 network relay apparatuses (a network apparatus 100 and two routers 401 and 402), and a host computer (a host 301).

The primary server 201 corresponding to the first processing apparatus in the claims of the invention is implemented as a server computer to provide a specific service, for example, web service to the host computer. The backup server 202 corresponding to the second processing apparatus in the claims of the invention stands by without providing the specific service in a normal state of the primary server 201 that operates to provide the service. The backup server 202 is activated to provide the specific service in place of the primary server 201 in an abnormal state of the primary server 201 that fails to operate and provide the service. Namely the primary server 201 and the backup server 202 are respectively a working server and a standby server. In the description hereof, the terms ‘processing apparatus’ and ‘server’ may be used as synonymous words.

The network apparatus 100 corresponding to the network relay apparatus in the claims of the invention is implemented as a layer 3 network relay apparatus of relaying packet communication between the two servers 201 and 202 and the host 301. The network apparatus 100 performs route control according to a routing protocol OSPF (Open Shortest Path First) to specify the primary server 201 as the working server and the backup server 202 as the standby server.

The network apparatus 100 has three interfaces 131 through 133, a configuration database 110, a VRF1 routing table 121 corresponding to the first route information storage in the claims of the invention, a VRF2 routing table 122 corresponding to the second route information storage in the claims of the invention, an interface database 140 corresponding to the VRF definition information storage in the claims of the invention, a packet forwarding processor 150, a direct route controller 160, a first OSPF processor 161, a second OSPF processor 162, and a failover processor 170. The respective functional components of the network apparatus 100 are implemented as a circuit structure including a central processing unit or CPU, a random access memory or RAM, and a read only memory or ROM. The CPU loads and executes a control program stored in the ROM on the RAM to actualize the respective functional components. Alternatively the respective functional components of the network apparatus 100 may be implemented by an ASIC (application specification integrated circuit) structure or an FPGA (field programmable gate array) structure.

The three interfaces 131 through 133 in the network apparatus 100 function to send packets to external devices connecting with the network apparatus 100 and to receive packets from the external devices. The interface 131 is connected to the router 401 via a line, and the router 401 is further connected to the primary server 201 via a line. The router 401 performs route control according to an OSPF protocol with the network apparatus 100. Similarly the interface 132 is connected to the router 402 via a line, and the router 402 is further connected to the backup server 202 via a line. The router 402 performs route control according to the OSPF protocol with the network apparatus 100. Due to the network disconnection based on VRF (Virtual Routing and Forwarding) technology, route control according to the OSPF protocol is not performed between the router 401 and the router 402 as described later in detail. The interface 133 is connected to the host 301 via a line.

The configuration database 110 stores configuration information of the network apparatus 100. The interface database 140 stores configuration information of all the interfaces included in the network apparatus 100. On reception of a packet at one of the interfaces included in the network apparatus 100, the packet forwarding processor 150 specifies an output interface for outputting the received packet and forwards the received packet from the specified output interface.

The direct route controller 160 works to obtain route information on a direct route and manage the route information. The direct route herein represents a route between one interface included in a network relay apparatus and an external device connected to the interface only by means of a line. The first OSPF processor 161 corresponding to the route information advertiser and the first state detector in the claims of the invention works to perform OSPF protocol-based operations with regard to a first OSPF domain and manage route information. The OSPF protocol-based operations include, for example, establishing an adjacency relationship, exchanging LSA (Link-State Advertisement), and detecting the state of a network or a change in network topology accompanied with, for example, a failure in a router. The second OSPF processor 162 corresponding to the route information advertiser and the second state detector in the claims of the invention works to perform OSPF protocol-based operations with regard to a second OSPF domain and manage route information. The failover processor 170 performs a changeover of the communication route to a backup route (hereafter referred to as ‘failover process’) in response to notification of an OSPF neighbor failure, for example, notification of a failure at a node or a line on the communication route, from the first OSPF processor 161 or the second OSPF processor 162.

The VRF1 routing table 121 and the VRF2 routing table 122 are required for communication made between a server and a host. The network apparatus 100 of this embodiment has the two routing tables 121 and 122, which are maintained by the VRF technology implemented on the network apparatus 100.

The VRF technology is generally implemented on the network relay apparatus having the layer 3 forwarding functions and is adopted to maintain multiple routing tables and enable the multiple routing tables simultaneously. Different routing tables stored in one identical apparatus have no interference with each other and are allowed to have independent operations. Namely one identical layer 3 address or an IP address may be allocated to the multiple different routing tables. The use of the multiple different routing tables with the identical IP address allocated thereto indicates the network disconnection or the configuration of different virtual networks.

The host 301 corresponding to the client apparatus in the claims of the invention is implemented as a personal computer and uses the specific service provided by the primary server 201 (or the backup server 202) via the network apparatus 100. In the description hereof, the terms ‘client apparatus’ and ‘host’ may be used as synonymous words. For the simplicity of illustration, the internal structures of the routers 401 and 402, as well as other network apparatuses, lines, and internal components of the network apparatus 100 that are not directly involved in the following explanation are omitted from the illustration of FIG. 1. Such omission is similarly adopted for subsequent equivalent diagrams.

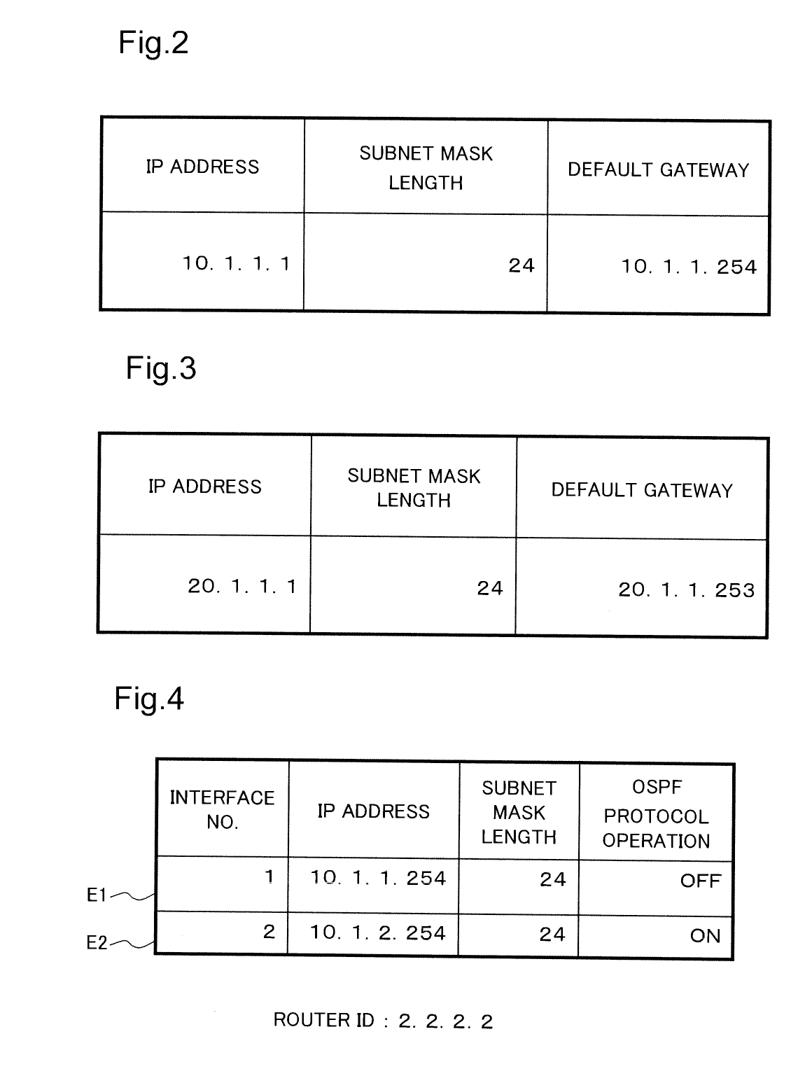

FIG. 2 is an explanatory diagrammatic representation of one example of IP address information on the two servers 201 and 202. An IP address, a subnet mask length, and a default gateway shown in FIG. 2 are respectively set in the primary server 201 and in the backup server 202 of the embodiment. Namely the same IP address is allocated to the primary server 201 and to the backup server 202. In a general network system, an IP address is used as an identifier for unequivocally identifying each apparatus, device, or interface as a component in the network. Namely it is not allowed to allocate an identical IP address to multiple different components. In the configuration of this embodiment, however, the VRF technology-based settings adopt different virtual networks to which the primary server 201 belongs and to which the backup server 202 belongs, and thereby allows an identical IP address to be allocated to both the primary server 201 and the backup server 202.

FIG. 3 is an explanatory diagrammatic representation of one example of IP address information on the host 301. An IP address, a subnet mask length, and a default gateway shown in FIG. 3 are set in the host 301 of the embodiment.

FIG. 4 is an explanatory diagrammatic representation of one example of setting information on the two routers 401 and 402. IP addresses, subnet mask lengths, and OSPF protocol operation statuses shown in FIG. 4 are respectively set in the router 401 and in the router 402 of the embodiment. Entries E1 and E2 in FIG. 4 are explained below with regard to the router 401 as an example. This explanation is similarly applicable to the router 402 with substitution of the router 401 and the primary server 201 with the router 402 and the backup server 202.

In the entry E1, the setting ‘1’ in an interface number field is a number used to identify a specific interface (not shown) of the router 401 connected to the primary server 201 via a line. The ON setting in an OSPF protocol operation field enables the OSPF protocol, while the OFF setting disables the OSPF protocol. Namely the entry E1 shows that the specific interface of the router 401 identified by the interface number ‘1’ disables the OSPF protocol for making connection with the primary server 201. In the entry E2, the setting ‘2’ in the interface number field is a number used to identify another specific interface (not shown) of the router 401 connected to the network apparatus 100 via a line. Namely the entry E2 shows that another specific interface of the router 401 identified by the interface number ‘2’ enables the OSPF protocol for making connection with the network apparatus 100.

A router ID is allocated as an identifier for unequivocally identifying each apparatus according to the OSPF protocol. An identical router ID ‘2.2.2.2’ is allocated to the two routers 401 and 402. The two routers 401 and 402 are allowed to have the same IP addresses and the same router ID. This is because the routers 401 and 402 belong to different networks based on the settings by the VRF technology, like the servers 201 and 202 explained above.

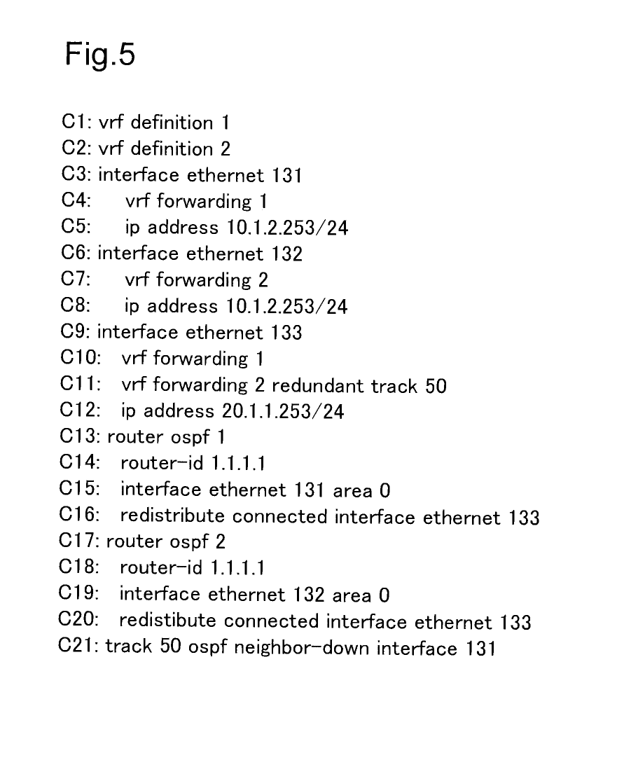

FIG. 5 is an explanatory diagrammatic representation of one example of configuration information used for defining the configuration of the network apparatus 100. This configuration information is stored in the configuration database 110. A line C1 defines a first VRF, and a line C2 defines a second VRF. A line C3 defines the interface 131. The interface 131 is an Ethernet (registered trademark) interface. The other interfaces 132 and 133 (described later) are also Ethernet (registered trademark) interfaces.

A line C4 defines that the interface 131 belongs to the first VRF. A line C5 defines an IP address and a subnet mask length of the interface 131. A line C6 defines the interface 132. A line C7 defines that the interface 132 belongs to the second VRF. A line C8 defines an IP address and a subnet mask length of the interface 132.

The same information is registered as the definitions of the IP address of the interface (line C5) and the IP address of the interface 132 (line C8). As mentioned above, in a general network system, an IP address is used as an identifier for unequivocally identifying each apparatus, device, or interface as a component in the network, so that it is not allowed to allocate an identical IP address to multiple different components. The interface 131 and the interface 132 belong to different VRFs (lines C4 and C7). This means that the VRF network to which the interface 131 belongs is different from the VRF network to which the interface 132 belongs. The same IP address can thus be allocated to the interfaces 131 and the interface 132. Similarly the same IP address and the same router ID can be set in the apparatuses (router 401 and primary server 201) belonging to the network connecting with the interface 131 or in the apparatuses (router 402 and backup server 202) belonging to the network connecting with the interface 132.

A line C9 defines the interface 133. A line C10 defines that the interface 133 belongs to the first VRF. A line C11 defines a changeover of the membership of the interface 133 to the second VRF on detection of an OSPF neighbor failure with the router 401 according to a status monitor rule 50 (described later in detail). A line C12 defines an IP address and a subnet mask length of the interface 133.

A line C13 defines a first OSPF domain. A line C14 defines a router ID of a router belonging to the first OSPF domain. A line C15 defines operation of the interface 131 with an OSPF area number of ‘0’. A line C16 defines advertisement for the IP address of the interface 133 and an IP address of an apparatus connected to the interface 133 via a line as route information of the first OSPF domain. The settings of the lines C13 to C16 cause the first OSPF processor 161 to perform, in cooperation with the router 401, route control according to the OSPF protocol and establish route information with regard to the primary server 201 and the router 401.

A line C17 defines a second OSPF domain. A line C18 defines a router ID of a router belonging to the second OSPF domain. A line C19 defines operation of the interface 132 with an OSPF area number of ‘0’. A line C20 defines advertisement for the IP address of the interface 133 and the IP address of the apparatus connected to the interface 133 via the line as route information of the second OSPF domain. The settings of the lines C17 to C20 cause the second OSPF processor 162 to perform, in cooperation with the router 402, route control according to the OSPF protocol and establish route information with regard to the backup server 202 and the router 402.

A line C21 defines monitoring blockage of neighbor information of the routing protocol OSPF working at the interface 131. Namely the line C21 defines a status monitor rule 50 for an OSPF neighbor between the network apparatus 100 and the router 401. For the simplicity of illustration, the configuration information of the network apparatus 100 that is not directly involved in the explanation is omitted from the illustration of FIG. 5. Such omission is similarly adopted for subsequent equivalent diagrams.

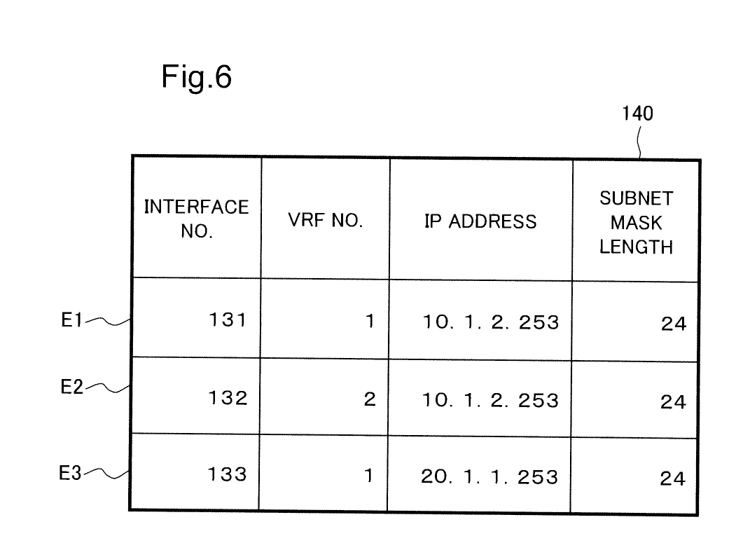

FIG. 6 is an explanatory diagrammatic representation of one example of the settings in the interface database 140. The interface database 140 has an interface number field, a VRF number field, an IP address field, and a subnet mask length field. The interface number field has registries of identifiers of the respective interfaces 131 through 133 included in the network apparatus 100. The VRF number field has registries of an identifier of the VRF network to which each of the interfaces 131 through 133 belongs. The IP address field has registries of IP addresses of the respective interfaces 131 through 133. The subnet mask length field has registries of a subnet mask representing how many bits out of the total bits of the corresponding IP address are allocated to a network address.

The interface database 140 is maintained, based on the configuration database 110 (FIG. 5) of defining the configuration information of the network apparatus 100. The information defined in the lines C3 through C5 in the configuration information described above with reference to FIG. 5 is registered in an entry E1 of the interface database 140. Similarly the information defined in the lines C6 through C8 and the information defined in the lines C9, C10, and C12 in the configuration information of FIG. 5 are registered in an entry E2 and in an entry E3. On reception of a packet at one of the interfaces 131 through 133, the packet forwarding processor 150 refers to the registries in the interface database 140 to specify a routing table as a search object for determining the forwarding destination of the received packet. The details of this procedure will be described later.

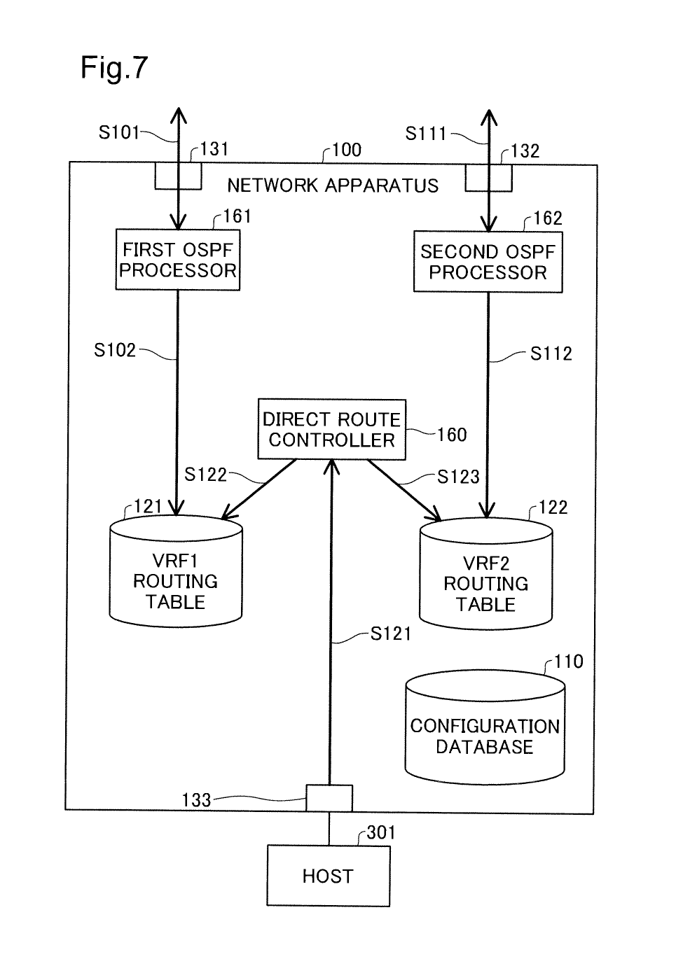

FIG. 7 is an explanatory diagrammatic representation of a processing flow for creating the VRF1 routing table 121 and the VRF2 routing table 122. At step S101, the first OSPF processor 161 performs OSPF protocol operations (packet sending and receiving operations) with the router 401 (not shown in FIG. 7) to establish route information between the network apparatus 100 and the router 401. At step S102, the first OSPF processor 161 stores the established route information into the VRF1 routing table 121. Such storage is ascribed to the operation of the first OSPF processor 161 at the interface 131 and the membership of the interface 131 to the first VRF network (lines C3 to C5 and lines C13 to C15 in FIG. 5).

At step S111, the second OSPF processor 162 performs OSPF protocol operations with the router 402 (not shown in FIG. 7) to establish route information between the network apparatus 100 and the router 402. At step S112, the second OSPF processor 162 stores the established route information into the VRF2 routing table 122. Such storage is ascribed to the operation of the second OSPF processor 162 at the interface 132 and the membership of the interface 132 to the second VRF network (lines C6 to C8 and lines C17 to C19 in FIG. 5).

At step S121, the direct route controller 160 performs, for example, ARP processing to read information on the apparatus (host 301) connected to the interface 133, from the interface 133 and establish route information. At step S122, the direct route controller 160 stores a direct route for the first VRF into the VRF1 routing table 121. Specifically the direct route controller 160 stores the IP address of the interface 131, the IP address of the apparatus connected to the interface 131 via the line, the IP address of the interface 133, and the IP address of the apparatus (host 301) connected to the interface 133 via the line into the VRF1 routing table 121. Such storage is ascribed to the membership of the interfaces 131 and 133 to the first VRF network (lines C3, C4, C9, and C10 in FIG. 5).

At step S123, the direct route controller 160 stores a direct route for the second VRF into the VRF2 routing table 122. Specifically the direct route controller 160 stores the IP address of the interface 132, the IP address of the apparatus connected to the interface 132 via the line, the IP address of the interface 133, and the IP address of the apparatus connected to the interface 133 via the line into the VRF2 routing table 122. Such storage is ascribed to the membership of the interface 132 to the second VRF network (lines C6 and C7 in FIG. 5) and a changeover to the second VRF on detection of a failure according to the status monitor rule 50 (lines C9 and C11 in FIG. 5).

A process of making direct routes for the interface 131 and the interface 132 and a process of establishing route information representing IP addresses set in the respective interfaces by the configuration database 110 are omitted from the illustration of FIG. 7.

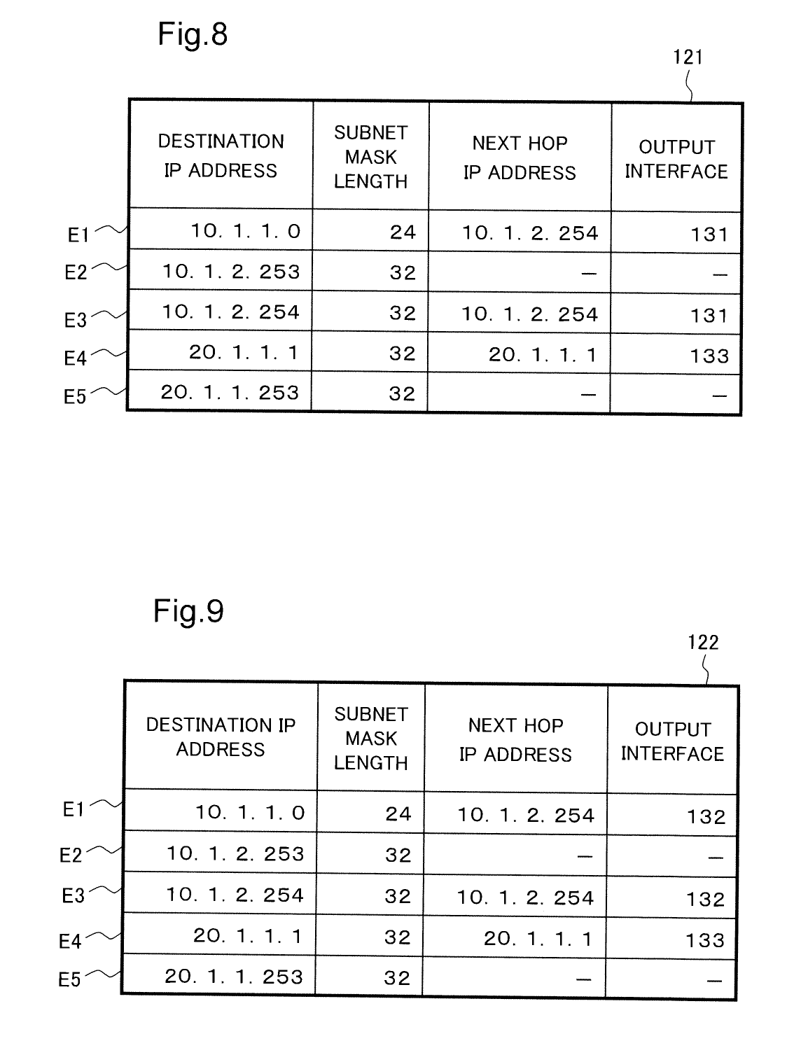

FIG. 8 is an explanatory diagrammatic representation of one example of the settings in the VRF1 routing table 121 based on the registries in the interface database 140 of FIG. 6. The VRF1 routing table 121 has a destination IP address field, a subnet mask length field, a next hop IP address field, and an output interface field. The destination IP address field has registries of a destination IP address. The subnet mask length field has registries of a subnet mask. The next hop IP address field has registries of an IP address of an apparatus as a next packet forwarding location to forward a packet from the network apparatus 100. The output interface field has registries of an identifier of an output interface to output a packet by the packet forwarding processor 150.

The VRF1 routing table 121 stores information on each specific interface having the registry of ‘1’ in the VRF number field of the interface database 140, information on each apparatus connected to the specific interface via a line, and the route information of the first VRF established by the first OSPF processor 161 (step S101 in FIG. 7). Namely the VRF1 routing table 121 stores information on the interfaces 131 and 133, the router 401, the primary server 201, and the host 301.

An entry E1 has registries of information on the primary server 201 as the route information of the first VRF established by the first OSPF processor 161. Specifically the IP address of the primary server 201 is registered in the destination IP address field. Because of the setting of a subnet mask having a 24-bit length, the IP address registered in the destination IP address field is ‘10.1.1.0’, although the IP address allocated to the primary server 201 is ‘10.1.1.1’. A value ‘24’ representing a network as the destination is registered in the subnet mask length field. The IP address of the apparatus (router 401) as a next packet forwarding location from the network apparatus 100 is registered in the next hop IP address field. This setting is ascribed to the connection of the network apparatus 100 to the primary server 201 via another apparatus (router 401). In the case where the network apparatus 100 is directly connected to the primary server 201 via a line, the IP address of the primary server 201 is registered in the next hop IP address field. The identifier of the interface of the network apparatus 100 connected to the router 401 is registered in the output interface field.

An entry E2 has registries of information on the interface 131 of the network apparatus 100. Specifically the IP address of the interface 131 is registered in the destination IP address field. A value ‘32’ representing an apparatus as the destination is registered in the subnet mask length field. When the network apparatus 100 receives a packet having the IP address of the interface 131 specified as the destination IP address, the network apparatus 100 is required to process the received packet without forwarding the packet. There are accordingly no registries in the next hop IP address field and in the output interface field (expressed by an indication of ‘-’).

An entry E3 has registries of information on the router 401. Specifically the IP address of the router 401 is registered in the destination IP address field. The value ‘32’ representing an apparatus as the destination is registered in the subnet mask length field. The IP address of the apparatus (router 401) as the next packet forwarding location from the network apparatus 100 is registered in the next hop IP address field. This setting is ascribed to the direct connection of the network apparatus 100 to the router 401 via a line. The identifier of the interface connecting with the router 401 is registered in the output interface field.

An entry E4 has registries of information on the host 301. The details of the respective fields in the entry E4 are similar to those of the entry E3 with regard to the router 401 and are thus not specifically explained here. An entry E5 has registries of information on the interface 133. The details of the respective fields in the entry E5 are similar to those of the entry E2 with regard to the interface 131 and are thus not specifically explained here.

FIG. 9 is an explanatory diagrammatic representation of one example of the settings in the VRF2 routing table 122 based on the registries in the interface database 140 of FIG. 6. The VRF2 routing table 122 has the similar table structure to that of the VRF1 routing table 121 described above. The VRF2 routing table 122 stores information on each specific interface having the registry of ‘2’ in the VRF number field of the interface database 140, information on each apparatus connected to the specific interface via a line, and the route information of the second VRF established by the second OSPF processor 162 (step S111 in FIG. 7). Here the VRF number field of the interface 133 has been changed over to the registry of ‘2’ (line C11 in FIG. 5). Namely the VRF2 routing table 122 stores information on the interfaces 132 and 133, the router 402, the backup server 202, and the host 301.

An entry E1 has registries of information on the backup server 202 as the route information of the second VRF established by the second OSPF processor 162. An entry E2 has registries of information on the interface 132. An entry E3 has registries of information on the router 402. An entry E4 has registries of information on the host 301. An entry E5 has registries of information on the interface 133. The details of the respective fields in the entry E1 of FIG. 9 are similar to those of the entry E1 with regard to the primary server 201 in the VRF1 routing table 121 of FIG. 8 and are thus not specifically explained here. The details of the respective fields in the entry E2, the entry E3, the entry E4, and the entry E5 of FIG. 9 are respectively similar to or equal to those of the entry E2 with regard to the interface 131, the entry E3 with regard to the router 401, the entry E4 with regard to the host 301, and the entry E5 with regard to the interface 133 in the VRF1 routing table 121 of FIG. 8 and are thus not specifically explained here.

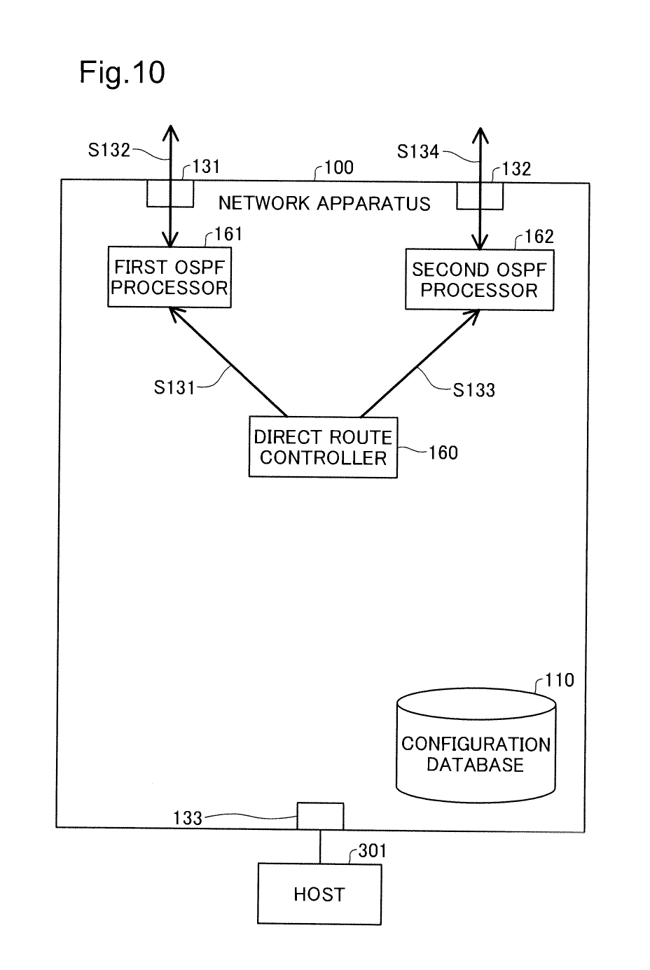

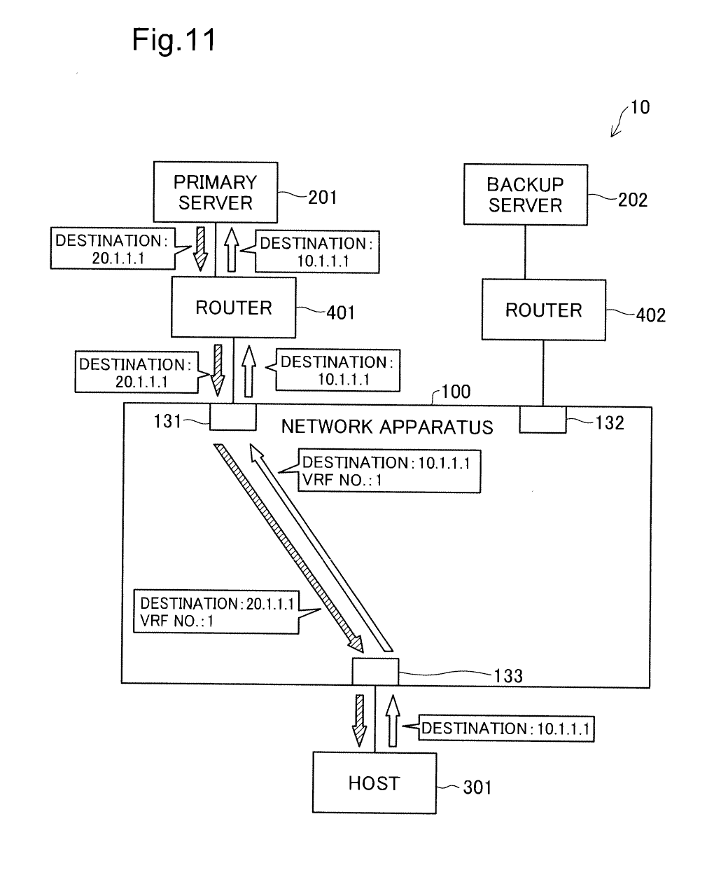

FIG. 10 is an explanatory diagrammatic representation of a processing flow for advertising direct route information managed by the direct route controller 160 according to the OSPF protocol. At step S131, the direct route controller 160 sends information on a direct route for the interface 133 to the first OSPF processor 161. At step S132, the first OSPF processor 161 advertises the received information on the direct route for the interface 133 as route information to the first OSPF domain. This operation is based on the definition of the line C16 in the configuration database 110 described above with reference to FIG. 5. At step S133, the direct route controller 160 sends information on a direct route for the interface 133 to the second OSPF processor 162. At step S134, the second OSPF processor 162 advertises the received information on the direct route for the interface 133 as route information to the second OSPF domain. This operation is based on the definition of the line C20 in the configuration database 110 described above with reference to FIG. 5. The process of advertising the route information may be confirmed through packet capture with a protocol analyzer.

### (A-2) Operations Before Detection of Failure

FIG. 11 is an explanatory diagrammatic representation of the operations of the network system 10 before the occurrence of a failure in an OSPF neighbor state with the router 401 as a monitor object. In the state of FIG. 11, the host 301 sends a request packet with a destination IP address of ‘10.1.1.1’, in order to have access to the server providing the service (either the primary server 201 or the backup server 202). The request packet is sent to an IP address specified in the own default gateway field described above with reference to FIG. 3 (i.e., the IP address of the interface 133).

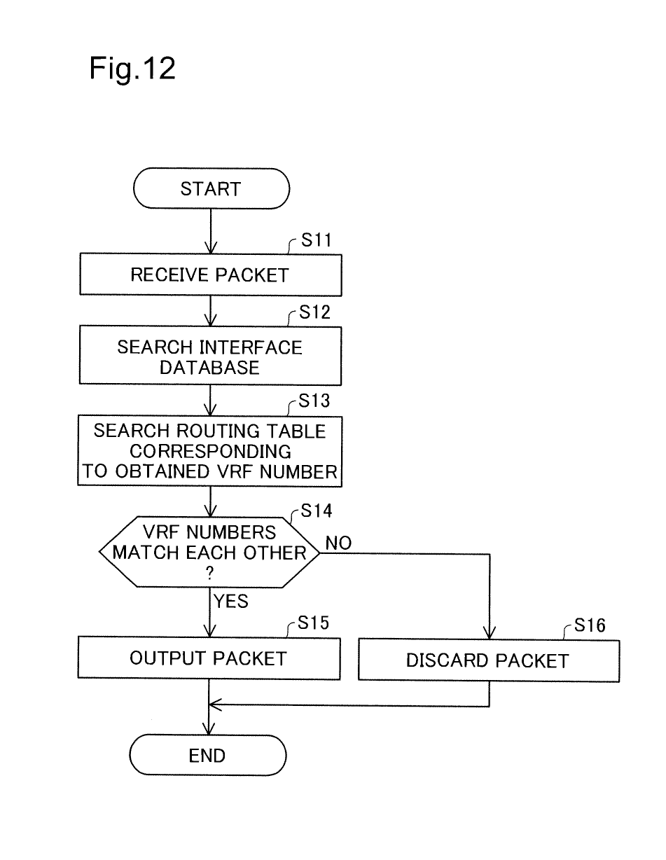

FIG. 12 is a flowchart showing a packet forwarding process performed in the network apparatus 100. The network apparatus 100 receives the packet from the host 301 at the interface 133 at step S11. The packet forwarding processor 150 searches the interface database 140 at subsequent step S12. Specifically the packet forwarding processor 150 searches the interface database 140 for any matching entry having the registry in the interface number field identical with the identifier of the packet-receiving interface or packet input interface. The packet forwarding processor 150 then obtains the registry in the VRF number field of the matching entry. In the illustrated example of FIGS. 6 and 11, the packet forwarding processor 150 obtains the registry of ‘1’ in the VRF number field of the matching entry E3 corresponding to the identifier ‘133’ of the packet input interface.

At step S13, the packet forwarding processor 150 searches the routing table specified by the obtained VRF number. In this embodiment, when the obtained VRF number is the first VRF routing table or the VRF1 routing table 121 is searched. When the obtained VRF number is ‘2’, on the other hand, the second VRF routing table or the VRF2 routing table 122 is searched. In the illustrated example of FIG. 11, the registry of ‘1’ in the VRF number field is obtained at step S12, so that the packet forwarding processor 150 searches the VRF1 routing table 121. Namely the packet forwarding processor 150 performs a route search with route information corresponding to a VRF network or a virtual network to which a packet source apparatus belongs.

The packet forwarding processor 150 searches the VRF1 routing table 121 for any matching entry having the registry in the destination IP address field identical with information representing a destination IP address included in a header of the received packet. The packet forwarding processor 150 then obtains the registry in the next hop IP address field and the registry in the output interface field of the matching entry. In the illustrated example of FIGS. 8 and 11, the packet forwarding processor 150 obtains the registry of ‘10.1.2.254’ in the next hop IP address field and the registry of ‘131’ in the output interface field of the matching entry E1 corresponding to the destination IP address ‘10.1.1.1’.

At step S14, the packet forwarding processor 150 determines whether the VRF number of a packet input interface matches the VRF number of a packet output interface. In the illustrated example of FIGS. 6 and 8, the VRF number ‘1’ of the packet input interface 133 is determined to match the VRF number ‘1’ of the packet output interface 131. Upon matching of the VRF numbers, at step S15, the packet forwarding processor 150 outputs the packet from the packet output interface specified by the registry obtained at step S13. The packet output from the packet output interface 131 is sent to the router 401. The router 401 receives the packet and forwards the packet to the apparatus having the destination IP address of ‘10.1.1.1’ (primary server 201), based on the route information (not shown) stored in the router 401. Upon mismatching of the VRF numbers, on the contrary, at step S16, the packet forwarding processor 150 discards the packet without forwarding.

In this manner, the request packet sent from the host 301 is forwarded to the primary server 201. The primary server 201 provides a required service based on the request packet received from the host 301 and sends back a reply packet to the host 301. A destination IP address of the reply packet is the IP address ‘20.1.1.1’ of the host 301. This reply packet is sent to an IP address specified in the own default gateway field described above with reference to FIG. 2 (i.e., the IP address of the router 401).

The router 401 receives the reply packet, reads the received reply packet according to the OSPF protocol, and forwards the reply packet to the interface 131 of the network apparatus 100, based on the route information stored in the router 401.

The network apparatus 100 receives the reply packet forwarded from the router 401 at the interface 131. The packet forwarding processor 150 subsequently performs the same series of packet forwarding process described above with reference to the flowchart of FIG. 12 with regard to the received reply packet and outputs the reply packet from a specified output interface. The reply packet sent from the primary server 201 is accordingly forwarded to the host 301. In the illustration of FIG. 11, open arrows represent the flow of a request packet from the host, and hatched arrows represent the flow of a reply packet from the server. These indications are similarly adopted for subsequent equivalent diagrams. The bidirectional communication between the host 301 and the primary server 201 is established in this manner and causes the primary server 201 to provide the host 301 with a service.

In this manner, the primary server 201 functions as the working server before the occurrence of a failure in the OSPF neighbor state with the router 401.

When the virtual network to which the packet source apparatus belongs is different from the virtual network to which the packet destination apparatus belongs, the packet forwarding processor 150 discards the packet without forwarding. This arrangement restricts communication between apparatuses belonging to different virtual networks, thus enhancing the safety in the network system.

The interface 132 connected to the backup server 202 has the registry of ‘2’ in the VRF number field of the interface database 140 shown in FIG. 6. This means that the interface 132 belongs to the second VRF. The primary server 201 and the host 301 respectively connected to the interface 131 and the interface 133 belonging to the first VRF belong to the same first VRF. The backup server 202 connected to the interface 132 belonging to the second VRF belongs to the second VRF. In the state of the registries of the interface database 140 shown in FIG. 6, the host 301 belongs to the different VRF network from the VRF network of the backup server 202 and accordingly does not establish communication with the backup server 202. Before detection of a failure, the backup server 202 functions as the standby server.

As a concrete example, it is assumed that the network apparatus 100 receives a packet to be directed to the host 301 from the backup server 202. The network apparatus 100 receives the packet from the backup server 202 at the interface 132 (step S11 in FIG. 12). The packet forwarding processor 150 searches the interface database 140 shown in FIG. 5 for any matching entry with the interface 132 and obtains the registry of ‘2’ in the VRF number field of the matching entry E2 (step S12 in FIG. 12). Based on this VRF number ‘2’, the packet forwarding processor 150 searches the VRF2 routing table 122 shown in FIG. 9 for any matching entry with the destination IP address of ‘20.1.1.1’ and obtains the registries in the next hop IP address field and the output interface field of the matching entry E4 (step S13 in FIG. 12). Since the VRF number ‘2’ of the packet input interface 132 does not match the VRF number ‘1’ of the packet output interface 133 (step S14 in FIG. 12), the packet forwarding processor 150 discards the received packet (step S16 in FIG. 12) and terminates the packet forwarding process.

As described above, a selected server is specifiable as the working server by giving an identical setting to both the VRF number of an interface connected to a server via a line or via another network relay apparatus and the VRF number of an interface connected to a host via a line or via another network relay apparatus. A selected server is specifiable as the standby server by giving different settings to the VRF number of the interface connected to the server via the line or via another network relay apparatus and to the VRF number of the interface connected to the host via the line or via another network relay apparatus.

### (A-3) Failover Process

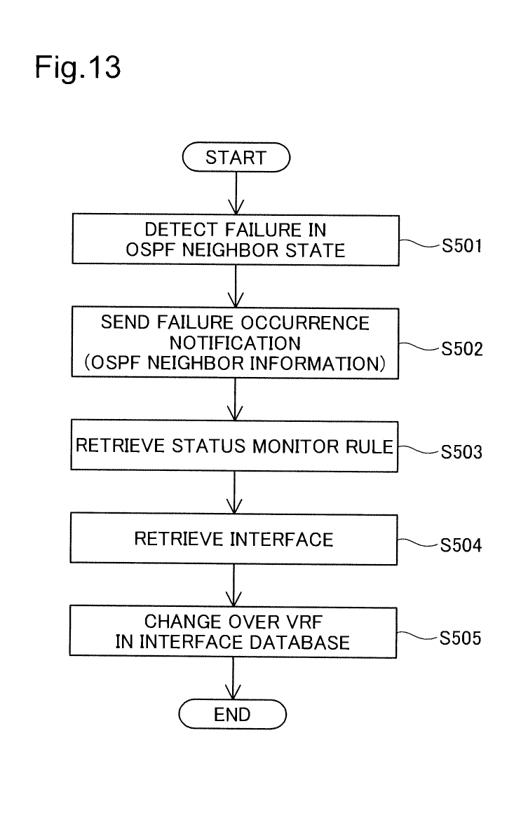

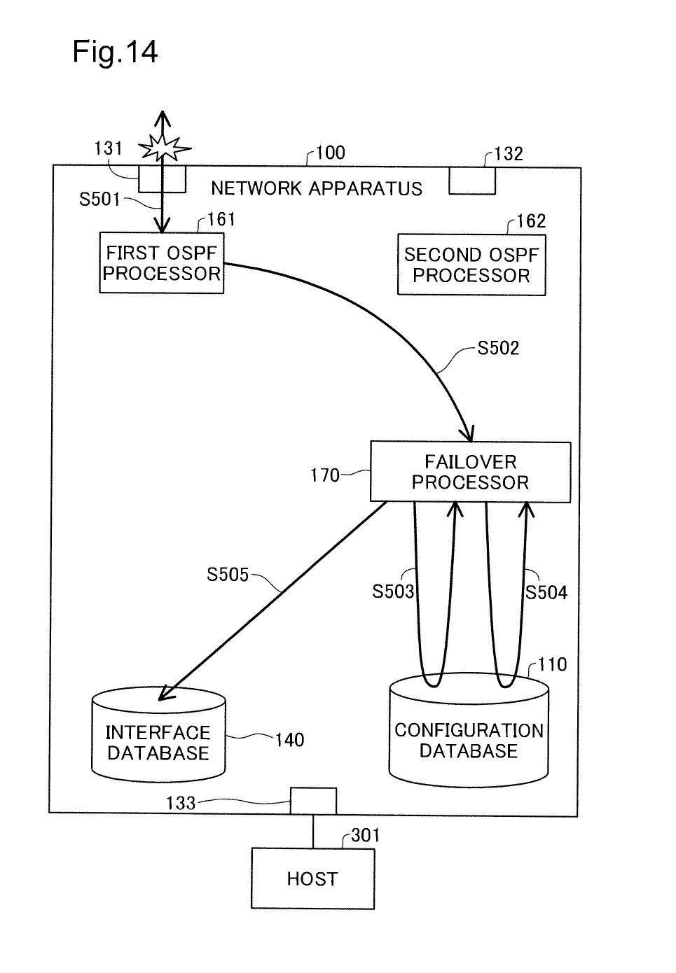

FIG. 13 is a flowchart showing a failover process. FIG. 14 is an explanatory diagrammatic representation of the operations of the network system 10 during the failover process. The step numbers shown in FIG. 14 correspond to the step numbers in the flowchart of FIG. 13. The following describes a series of failover process performed by the first OSPF processor 161. The second OSPF processor 162 performs the similar series of failover process.

At step S501, the first OSPF processor 161 detects the occurrence of a failure in the OSPF neighbor state with the router 401. For example, in the event of no reception of a Hello packet, which is expected to receive from a router at regular intervals, for a preset time period, the first OSPF processor 161 detects the occurrence of a failure in the OSPF neighbor state. At step S502, the first OSPF processor 161 sends OSPF neighbor information (information on the router with the occurrence of a failure in the OSPF neighbor state) as a failure occurrence notification to the failover processor 170.

At step S503, the failover processor 170 retrieves a status monitor rule corresponding to the OSPF neighbor information notified at step S502 from the configuration database 110. Specifically the failover processor 170 retrieves a status monitor rule from the definitions in the configuration database 110, based on the IP address of the router specified by the OSPF neighbor information and the interface number of the interface connected to the router. For example, the failover processor 170 retrieves an identification number ‘50’ of the status monitor rule defined on the line C21 in the configuration database 110 of FIG. 5, based on the IP address of the router 401 and the interface number ‘131’.

At step S504, the failover processor 170 retrieves an interface adopting the retrieved status monitor rule. Specifically the failover processor 170 retrieves an identification number of an interface adopting the status monitor rule and the specification of the status monitor rule from the configuration database 110, based on the identification number of the status monitor rule retrieved at step S503. For example, based on the identification number ‘50’ of the status monitor rule, the failover processor 170 retrieves an interface number ‘133’ and the specification of the status monitor rule 50 (representing a changeover of the membership of the interface 133 to the second VRF network on detection of a failure in the OSPF neighbor state with the router 401) defined on the line C11 in the configuration database 110 of FIG. 5. At step S505, the failover processor 170 updates the VRF number of the interface database 140 (and of the configuration database 110), based on the specification of the status monitor rule retrieved at step S504.

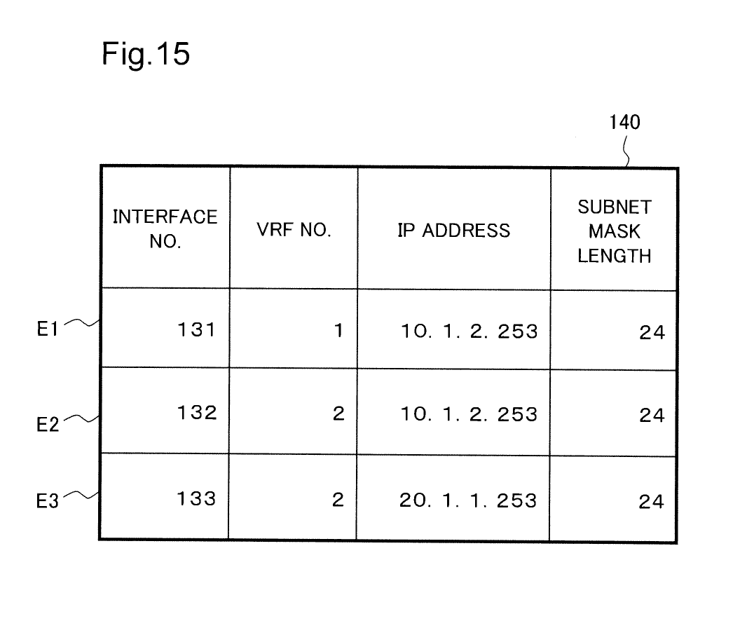

FIG. 15 is an explanatory diagrammatic representation of the registries in the interface database 140 after the update at step S505 in the failover process of FIG. 13. The difference from the registries in the interface database 140 of FIG. 6 before detection of a failure is that the registry in the VRF number field has been changed over to ‘2’ in the entry E3 having the registry of ‘133’ in the interface number field.

(A-4) Operations after Detection of Failure

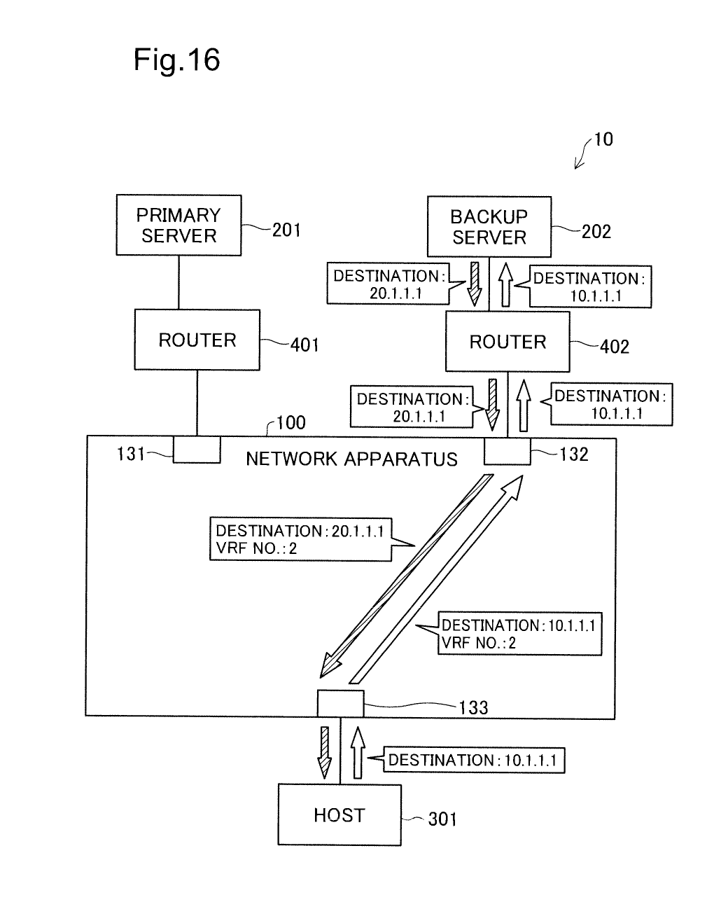

FIG. 16 is an explanatory diagrammatic representation of the operations of the network system 10 after the occurrence of a failure in the OSPF neighbor state with the router 401 as the monitor object. In the state of FIG. 16, the host 301 sends a request packet with a destination IP address of ‘10.1.1.1’, in order to have access to the server providing the service (either the primary server 201 or the backup server 202). The request packet is sent to an IP address specified in the own default gateway field described above with reference to FIG. 3 (i.e., the IP address of the interface 133).

The network apparatus 100 receives the packet from the host 301 at the interface 133 (step S11 in FIG. 12). The packet forwarding processor 150 searches the updated interface database 140 shown in FIG. 15 for any matching entry with the interface 133 and obtains the registry of ‘2’ in the VRF number field of the matching entry E3 (step S12 in FIG. 12). Based on this VRF number ‘2’, the packet forwarding processor 150 searches the VRF2 routing table 122 shown in FIG. 9 (step S13 in FIG. 12). Since the VRF number ‘2’ of the packet input interface 133 matches the VRF number ‘2’ of the packet output interface 132, the packet forwarding processor 150 outputs the packet from the output interface 132 obtained at step S13 (step S15 in FIG. 12). The packet output from the interface 132 is sent to the router 402. The router 402 receives the packet and forwards the packet to the apparatus having the destination IP address of ‘10.1.1.1’ (backup server 202), based on the route information (not shown) stored in the router 402.

As described above, the request packet sent from the host 301 is forwarded to the backup server 202. The backup server 202 provides a required service based on the request packet received from the host 301 and sends back a reply packet to the host 301. A destination IP address of the reply packet is the IP address ‘20.1.1.1’ of the host 301. This reply packet is sent to an IP address specified in the own default gateway field described above with reference to FIG. 2 (i.e., the IP address of the interface 132).

The network apparatus 100 receives the reply packet from the backup server 202 at the interface 132. The packet forwarding processor 150 performs the same series of processing as the processing flow of FIG. 12 with regard to the received reply packet and outputs the reply packet from a specified packet output interface. The reply packet from the backup server 202 is accordingly forwarded to the host 301.

In this manner, the backup server 202 functions as the working server after the occurrence of a failure in the OSPF neighbor state with the router 401.

As described above, the network apparatus 100 of the embodiment creates and stores in advance the VRF1 routing table 121 as the route information of the first virtual network and the VRF2 routing table 122 as the route information of the second virtual network in the respective storages thereof. A backup route to be computed in advance is only for the two OSPF domains, i.e., the first OSPF domain and the second OSPF domain. The computational cost for providing the backup route in this embodiment is thus substantially equivalent to the computational cost of the conventional routing protocol. The pre-computation of the backup route requires only information on the interfaces corresponding to the respective VRFs and does not require the restricted conditions of the IP-FRR technology, thus allowing for the flexible design of the network system.

The packet forwarding processor 150 uses the route information of a normal virtual network with no occurrence of a failure on the route out of the first virtual network and the second virtual network to forward a received packet to the first processing apparatus (primary server 201) or to the second processing apparatus (backup server 202). When the first state detector (first OSPF processor 161) detects a failure on the route in the first virtual network, the failover processor 170 updates the VRF definition information to change over the membership of the client apparatus (host 301) from the first virtual network to the second virtual network. The membership of the client apparatus is similarly changed over on detection of a failure on the route in the second virtual network. In the event of the occurrence of a failure on the route in a virtual network, the failover process is performed to make a changeover to the backup route within a short time by simply updating the VRF definition information. The configuration of this embodiment does not require the MPLS functions for the failover process and thus reduces the cost for the establishment and the operations of the network system.

The configuration of this embodiment provides the network system with the high reliability and the high availability that has the computational cost of the routing protocol for computing the backup route substantially equivalent to the computational cost of the conventional routing protocol without requiring the MPLS functions.

### B. Second Embodiment

A configuration of providing redundant communication routes to a processing apparatus in place of the duplex processing apparatuses (servers) is described below as a second embodiment according to the invention. The description is mainly focused on the different structures and the different operations from those of the first embodiment. The like components in the second embodiment to those in the first embodiment are shown by the like numerals and symbols and are not specifically described here.

### (B-1) System Configuration

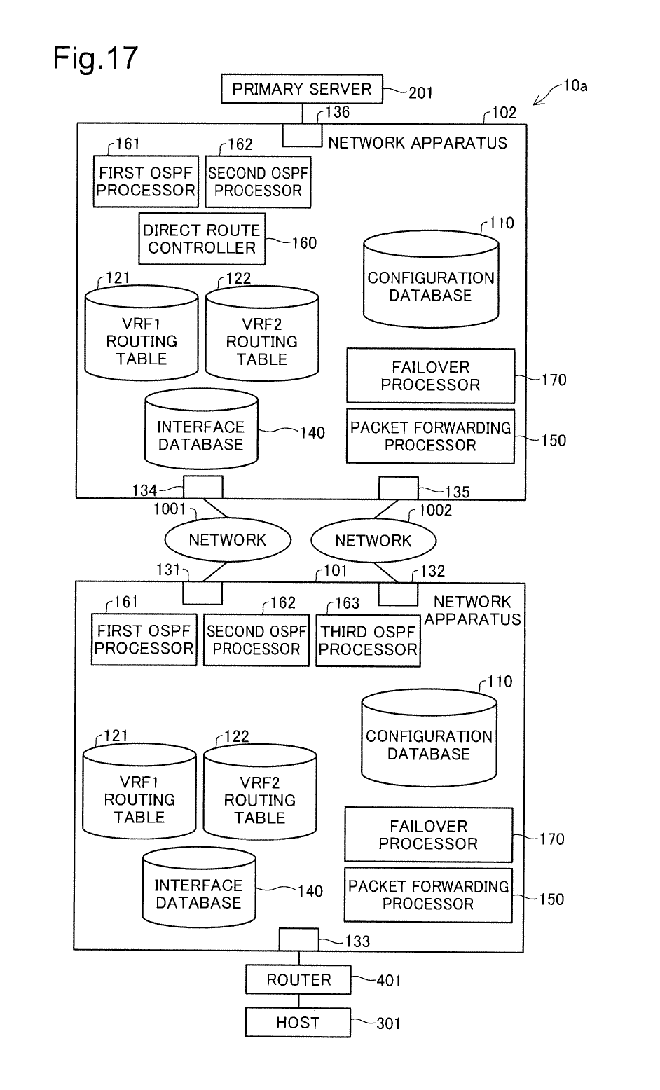

FIG. 17 is an explanatory diagrammatic representation of the general configuration of a network system 10a according to the second embodiment. The primary differences from the network system 10 of the first embodiment shown in FIG. 1 include omission of the backup server 202, the presence of two network apparatuses 101 and 102 in place of the single network apparatus 100, and the network configuration. Otherwise the configuration of the second embodiment is similar to the configuration of the first embodiment.

The network apparatuses 101 and 102 corresponding to the network relay apparatuses in the claims of the invention are implemented as layer 3 network relay apparatuses of relaying packet communication between a primary server 201 and a host 301.

The network apparatus 101 corresponding to the second network relay apparatus in the claims of the invention has three interfaces 131 through 133 and a third OSPF processor 163 in addition to a first OSPF processor 161 and a second OSPF processor 162. The three interfaces 131 through 133 in the network apparatus 101 function to send packets to external devices connecting with the network apparatus 101 and to receive packets from the external devices. The interface 131 is connected to at least one router constituting a network 1001 via a line. The interface 132 is connected to at least one router constituting a network 1002 via a line. The interface 133 is connected to a router 401 via a line. The router 401 is further connected to the host 301 via a line. The network apparatus 101 performs route control according to the OSPF protocol with the at least one router constituting the network 1001, the at least one router constituting the network 1002, the router 401, and the network apparatus 102. The third OSPF processor 163 works to perform OSPF protocol-based operations with regard to a third OSPF domain and manage route information.

The network apparatus 102 corresponding to the first network relay apparatus in the claims of the invention has three interfaces 134 through 136. The three interfaces 134 through 136 in the network apparatus 102 function to send packets to external devices connecting with the network apparatus 102 and to receive packets from the external devices. The interface 134 is connected to at least one router constituting the network 1001 via a line. The interface 135 is connected to at least one router constituting the network 1002 via a line. The interface 136 is connected to the primary server 201 via a line. The network apparatus 102 performs route control according to the OSPF protocol with the at least one router constituting the network 1001, the at least one router constituting the network 1002, and the network apparatus 101.

The networks 1001 and 1002 are established to relay communication between the primary server 201 and the host 301 and respectively include at least one router (not shown). Each router included in the network 1001 performs route control according to the OSPF protocol with the network apparatus 101, the network apparatus 102, and the other routers included in the network 1001. Each router included in the network 1002 performs route control according to the OSPF protocol with the network apparatus 101, the network apparatus 102, and the other routers included in the network 1002. Due to the network disconnection based on the VRF technology, route control according to the OSPF protocol is not performed between the at least one router constituting the network 1001 and the at least one router constituting the network 1002.

Namely the first interface (interface 131) of the network apparatus 101 indirectly connects with the first interface (interface 134) of the network apparatus 102 via another network (network 1001). Similarly the second interface (interface 132) of the network apparatus 101 indirectly connects with the second interface (interface 135) of the network apparatus 102 via another network (network 1002). The networks 1001 and 1002 may be omitted from the system configuration if not required.

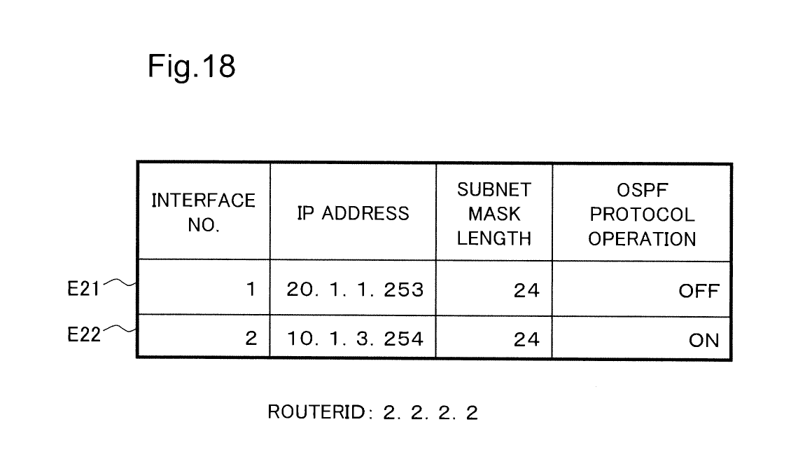

FIG. 18 is an explanatory diagrammatic representation of one example of setting information on the router 401. IP addresses, subnet mask lengths, and OSPF protocol operation statuses shown in FIG. 18 are set in the router 401 of the embodiment. In an entry E21, the setting ‘1’ in an interface number field is a number used to identify a specific interface (not shown) of the router 401 connected to the host 301 via a line. Namely the entry E21 shows that the specific interface of the router 401 identified by the interface number ‘1’ disables the OSPF protocol for making connection with the host 301. In an entry E22, the setting ‘2’ in the interface number field is a number used to identify another specific interface (not shown) of the router 401 connected to the network apparatus 101 via a line. Namely the entry E22 shows that another specific interface of the router 401 identified by the interface number ‘2’ enables the OSPF protocol for making connection with the network apparatus 101. A router ID ‘2.2.2.2’ is allocated to the router 401.

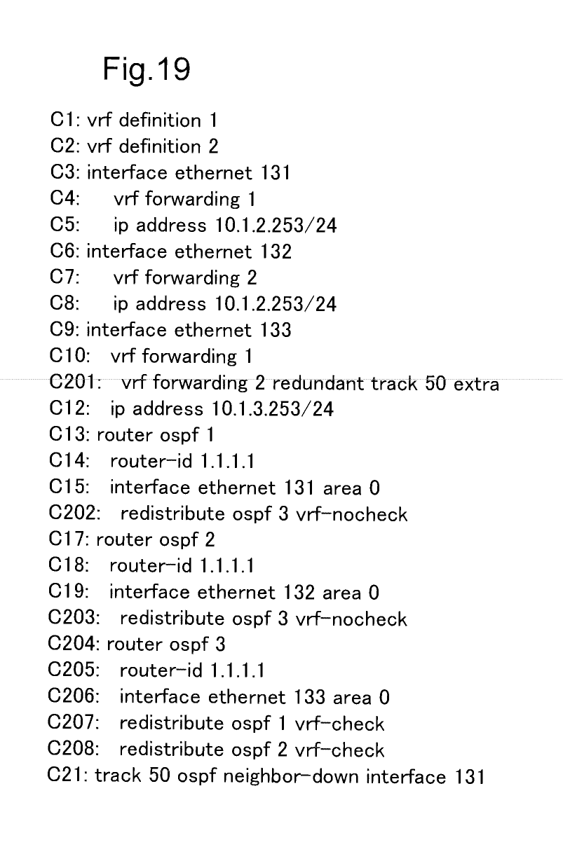

FIG. 19 is an explanatory diagrammatic representation of one example of configuration information used for defining the configuration of the network apparatus 101. This configuration information is stored in a configuration database 110 of the network apparatus 101. The difference from the configuration information of the first embodiment shown in FIG. 5 is deletion of the lines C11, C16, and C20 and addition of lines C201 to C208. Otherwise the configuration information in the network apparatus 101 is similar to the configuration information of the first embodiment.

A line C201 has definitions a) and b) given below:

a) On detection of an OSPF neighbor failure with a router in the network 1001 according to a status monitor rule 50, the membership of the interface 133 is to be changed over to the second VRF network; and

b) Even when the VRF network to which an input interface of a packet belongs is different from the VRF network to which an output interface of the packet belongs, the packet is not to be discarded but is to be forwarded.

A line C202 has definitions c) and d) given below:

c) Route information of a third OSPF domain is to be advertised as route information of a first OSPF domain; and

d) Even when the route information of the third OSPF domain and the route information of the first OSPF domain are related to different VRF networks, the route information is to be advertised.

The settings of the lines C13 to C15 and C202 cause the first OSPF processor 161 to perform, in cooperation with the at least one router in the network 1001 and the network apparatus 102, route control according to the OSPF protocol and establish route information.

A line C203 has definitions e) and f) given below;

e) Route information of the third OSPF domain is to be advertised as route information of a second OSPF domain; and

f) Even when the route information of the third OSPF domain and the route information of the second OSPF domain are related to different VRF networks, the route information is to be advertised.

The settings of the lines C17 to C19 and C203 cause the second OSPF processor 162 to perform, in cooperation with the at least one router in the network 1002 and the network apparatus 101, route control according to the OSPF protocol and establish route information.

A line C204 defines the third OSPF domain. A line C205 defines a router ID of a router belonging to the third OSPF domain. A line C206 defines operation of the interface 133 with an OSPF area number of ‘0’. A line C207 has definitions g) and h) given below:

g) Route information of the first OSPF domain is to be advertised as route information of the third OSPF domain; and

h) Only when the route information of the first OSPF domain and the route information of the third OSPF domain are related to one identical VRF network, the route information is to be advertised.

A line C208 has definitions similar to those of the line C207 with regard to the route information of the second OSPF domain and the route information of the third OSPF domain. The settings of the lines C204 to C208 cause the third OSPF processor 163 to perform, in cooperation with the router 401, route control according to the OSPF protocol and establish route information. A line C21 defines monitoring blockage of neighbor information of the routing protocol OSPF working at the interface 131. Namely the line C21 defines the status monitor rule 50 for an OSPF neighbor between the network apparatus 101 and the router included in the network 1001.

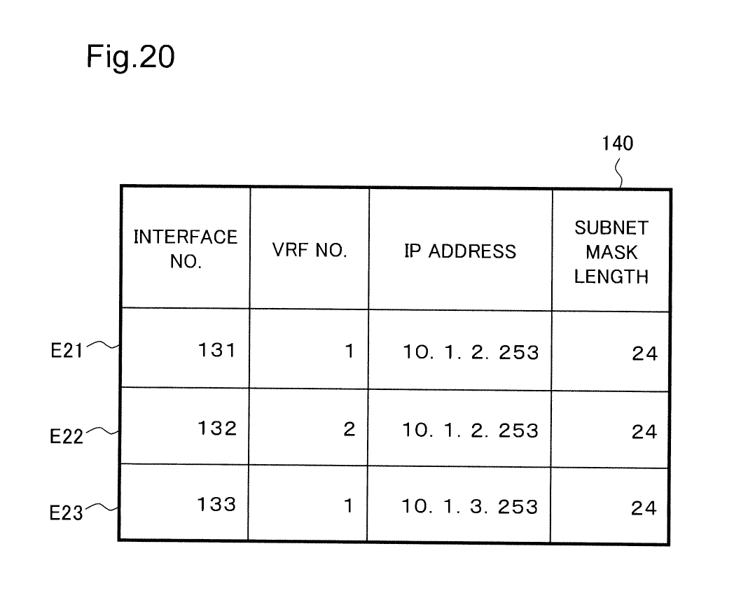

FIG. 20 is an explanatory diagrammatic representation of one example of the settings in an interface database 140 included in the network apparatus 101. The difference from the settings in the interface database 140 of the first embodiment shown in FIG. 6 is only the registry of an entry E23 (corresponding to the entry E3 in FIG. 6), i.e., an IP address of the interface 133.

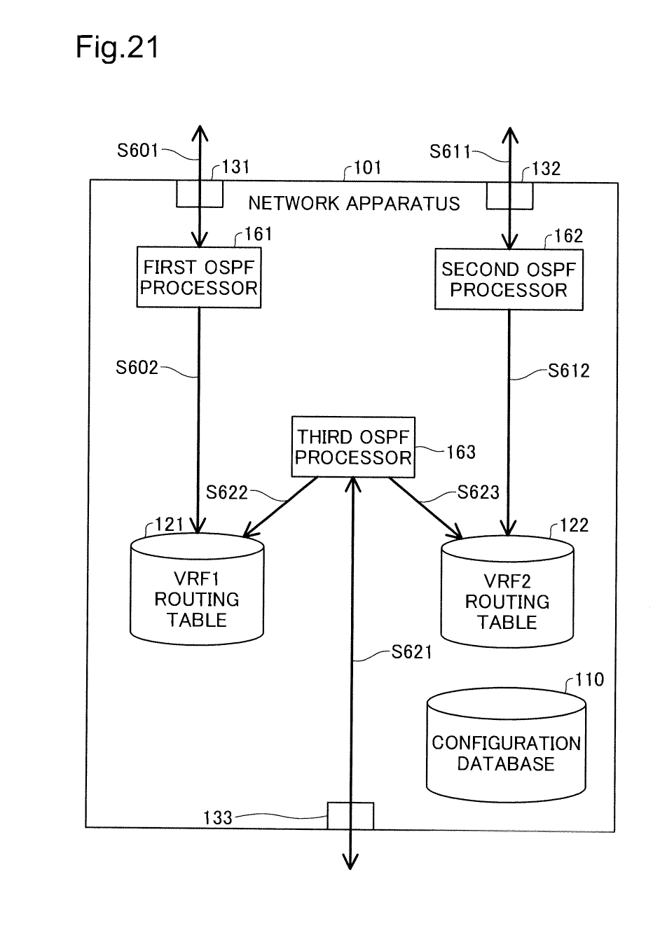

FIG. 21 is an explanatory diagrammatic representation of a processing flow for creating a VRF1 routing table 121 and a VRF2 routing table 122 in the network apparatus 101. The following describes the process of creating the VRF routing tables for the network apparatus 101. This explanation is similarly applicable to creation of VRF routing tables for the network apparatus 102.

At step S601, the first OSPF processor 161 performs OSPF protocol operations with a router (not shown) belonging to the first OSPF domain in the network 1001 to establish route information between the network apparatus 101 and the router included in the network 1001. At step S602, the first OSPF processor 161 stores the established route information into the VRF1 routing table 121 (lines C3 to C5 and lines C13 to C15 in FIG. 19).

At step S611, the second OSPF processor 162 performs OSPF protocol operations with a router (not shown) belonging to the second OSPF domain in the network 1002 to establish route information between the network apparatus 101 and the router included in the network 1002. At step S612, the second OSPF processor 162 stores the established routed information into the VRF2 routing table 122 (lines C6 to C8 and lines C17 to C19 in FIG. 19).

At step S621, the third OSPF processor 163 performs OSPF protocol operations with the router 401 (omitted from the illustration of FIG. 21) to establish route information between the network apparatus 101 and the router 401. At step S622, the third OSPF processor 163 stores the established route information into the VRF1 routing table 121. Such storage is ascribed to the membership of the interfaces 131 and 133 to the first VRF network (lines C3, C4, C9, and C10 in FIG. 19). At step S623, the third OSPF processor 163 stores the established route information into the VRF2 routing table 122. Such storage is ascribed to the membership of the interface 132 to the second VRF network (lines C6 and C7 in FIG. 19) and a changeover to the second VRF on detection of a failure according to the status monitor rule 50 (lines C9 and C201 in FIG. 19).

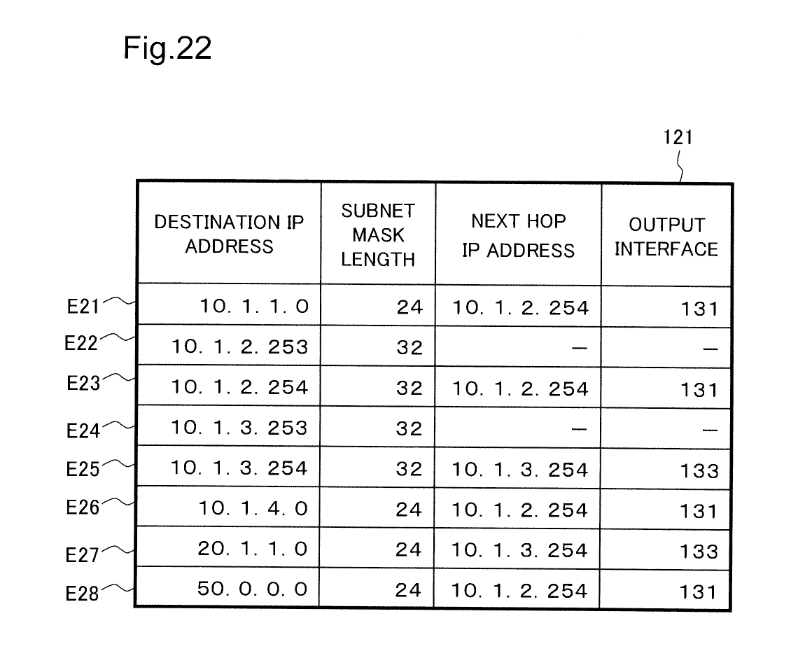

FIG. 22 is an explanatory diagrammatic representation of one example of the settings in the VRF1 routing table 121 of the network apparatus 101 based on the registries in the interface database 140 of FIG. 20. The difference from the settings in the VRF1 routing table 121 of the first embodiment shown in FIG. 8 is the registries of respective entries.

The VRF1 routing table 121 stores information on each specific interface having the registry of ‘1’ in the VRF number field of the interface database 140, information on each apparatus connected to the specific interface via a line, the route information of the first VRF established by the first OSPF processor 161 (step S601 in FIG. 21), and the route information of the first VRF established by the third OSPF processor 163 (step S621 in FIG. 21). Namely the VRF1 routing table 121 stores information on the interfaces 131 and 133, at least one router and/or external device belonging to the first OSPF domain in the network 1001, the primary server 201, the router 401, and the host 301.

An entry E21 has registries of information on the primary server 201 as the route information of the first VRF established by the first OSPF processor 161. The details of the respective fields in the entry E21 are similar to those of the entry E1 shown in FIG. 8 with substitution of the network apparatus 100 and the router 401 with the network apparatus 101 and the router in the network 1001. An entry E22 has registries of information on the interface 131 of the network apparatus 101. The details of the respective fields in the entry E22 are similar to those of the entry E2 shown in FIG. 8. An entry E23 has registries of information on the router in the network 1001. The details of the respective fields in the entry E23 are similar to those of the entry E3 shown in FIG. 8 with substitution of the network apparatus 100 and the router 401 with the network apparatus 101 and the router in the network 1001. An entry E24 has registries of information on the interface 133 of the network apparatus 101. The details of the respective fields in the entry E24 are similar to those of the entry E5 shown in FIG. 8. An entry E25 has registries of information on the router 401. The details of the respective fields in the entry E25 are similar to those of the entry E3 shown in FIG. 8 with substitution of the network apparatus 100 with the network apparatus 101.

An entry E26 has registries of information on an external device as the route information of the first VRF established by the first OSPF processor 161. Specifically an IP address of the external device is registered in the destination IP address field. A value ‘24’ representing a network as the destination is registered in the subnet mask length field. An IP address of the apparatus (router in the network 1001) as a next packet forwarding location from the network apparatus 101 is registered in the next hop IP address field. An identifier of the interface of the network apparatus 101 connected to the router in the network 1001 is registered in the output interface field.

An entry E27 has registries of information on the host 301 as the route information of the first VRF established by the third OSPF processor 163. Specifically an IP address of the host 301 is registered in the destination IP address field. The value ‘24’ representing the network as the destination is registered in the subnet mask length field. An IP address of the apparatus (router 401) as a next packet forwarding location from the network apparatus 101 is registered in the next hop IP address field. An identifier of the interface of the network apparatus 101 connected to the router 401 is registered in the output interface field.

An entry E28 has registries of information on a subnetwork (not shown) in the network 1001 as the route information of the first VRF established by the first OSPF processor 161. Specifically an IP address allocated to the subnetwork in the network 1001 is registered in the destination IP address field. The value ‘24’ representing the network as the destination is registered in the subnet mask length field. The IP address of the apparatus (router in the network 1001) as the next packet forwarding location from the network apparatus 101 is registered in the next hop IP address field. The identifier of the interface of the network apparatus 101 connected to the router in the network 1001 is registered in the output interface field.

The route information of the entry E21, the route information of the entry E26, and the route information of the entry E28 are advertised as the route information of the third OSPF domain by the third OSPF processor 163 (line C207 in FIG. 19). The route information of the entry E27 is advertised as the route information of the first OSPF domain by the first OSPF processor 161 (line C202 in FIG. 19).

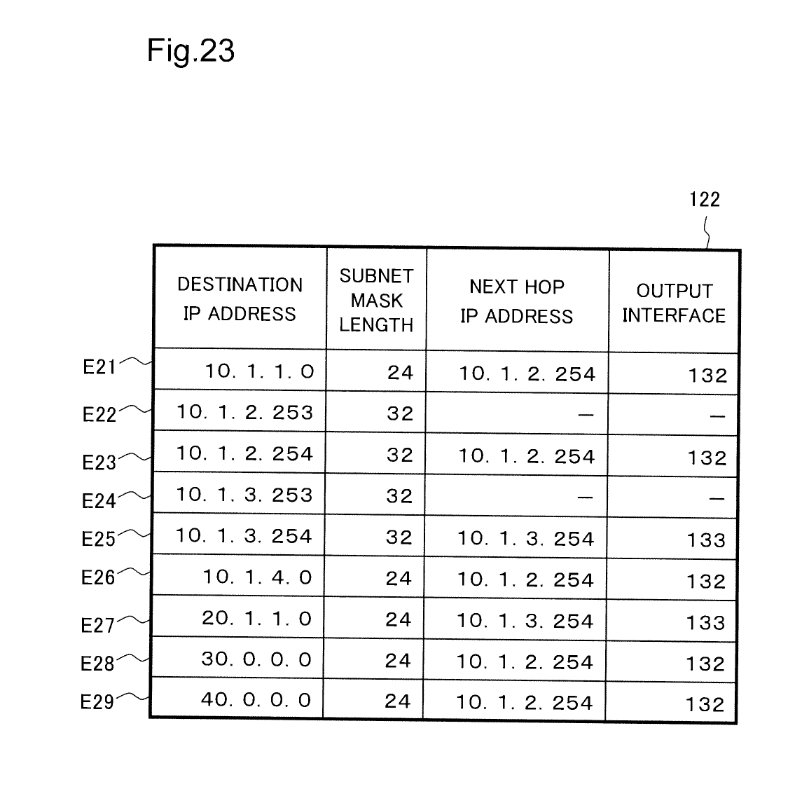

FIG. 23 is an explanatory diagrammatic representation of one example of the settings in the VRF2 routing table 122 of the network apparatus 101 based on the registries in the interface database 140 of FIG. 20. The difference from the settings in the VRF2 routing table 122 of the first embodiment shown in FIG. 9 is the registries of respective entries.

The VRF2 routing table 122 stores information on each specific interface having the registry of ‘2’ in the VRF number field of the interface database 140, information on each apparatus connected to the specific interface via a line, the route information of the second VRF established by the second OSPF processor 162 (step S611 in FIG. 21), and the route information of the first VRF established by the third OSPF processor 163 (step S621 in FIG. 21). Namely the VRF2 routing table 122 stores information on the interfaces 132 and 133, at least one router and/or external device belonging to the second OSPF domain in the network 1002, the primary server 201, the router 401, and the host 301.

An entry E21 has registries of information on the primary server 201 as the route information of the second VRF established by the second OSPF processor 162. An entry E22 has registries of information on the interface 132 of the network apparatus 101. An entry E23 has registries of information on the router in the network 1002. An entry E24 has registries of information on the interface 133 of the network apparatus 101. An entry E25 has registries of information on the router 401. An entry E26 has registries of information on an external device as the route information of the second VRF established by the second OSPF processor 162. An entry E27 has registries of information on the host 301 as the route information of the first VRF established by the third OSPF processor 163. An entry E28 has registries of information on a subnetwork (not shown) in the network 1002 as the route information of the second VRF established by the second OSPF processor 162. An entry E29 has registries of information on a subnetwork (not shown) in the network 1002 as the route information of the second VRF established by the second OSPF processor 162.

The details of the respective fields in the entry E21 of FIG. 23 are similar to those of the entry E21 with regard to the primary server 201 in the VRF1 routing table 121 of FIG. 22 and are thus not specifically explained here. The details of the respective fields in the entry E22, the entry E23, the entry E24, the entry E25, the entry E26, the entry E27, the entry E28, and the entry E29 of FIG. 23 are respectively similar to or equal to those of the entry E22 with regard to the interface 131, the entry E23 with regard to the router in the network 1001, the entry E24 with regard to the interface 133, the entry E25 with regard to the router 401, the entry E26 with regard to the external device as the route information of the first VRF established by the first OSPF processor 161, the entry E27 with regard to the host 301, the entry E28 with regard to the subnetwork in the network 1001, and the entry E28 with regard to the subnetwork in the network 1001 in the VRF1 routing table 121 of FIG. 22 and are thus not specifically explained here.

None of the route information of the entry E21, the route information of the entry E26, the route information of the entry E28, and the route information of the entry E29 is not advertised as the route information of the third OSPF domain by the third OSPF processor 163 (line C208 in FIG. 19). Such non-advertisement is ascribed to the different VRF numbers of the interfaces. The route information of the entry E27 is advertised as the route information of the first OSPF domain by the first OSPF processor 161 (line C203 in FIG. 19). The details of the advertisement will be described later.

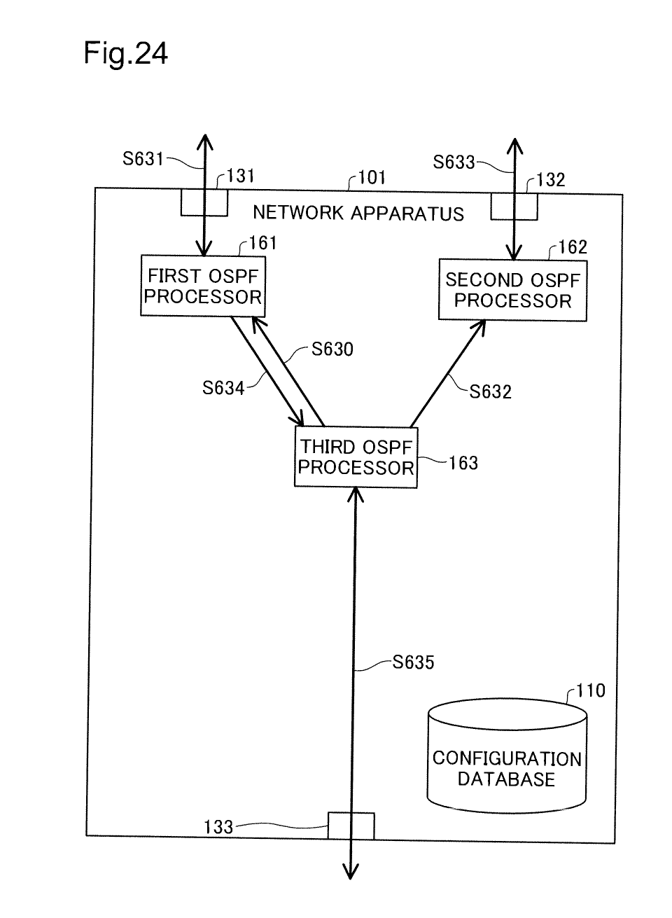

FIG. 24 is an explanatory diagrammatic representation of a processing flow for advertising the mutual route information by the first OSPF processor 161, the second OSPF processor 162, and the third OSPF processor 163 according to the OSPF protocol. The following describes the process of advertising route information by the respective OSPF processors in the network apparatus 101. This explanation is similarly applicable to a process of advertising route information by the respective OSPF processors in the network apparatus 102.

At step S630, the third OSPF processor 163 sends the route information of the third OSPF domain, i.e., the route information on the host 301, to the first OSPF processor 161. At step S631, the first OSPF processor 161 advertises the received route information as the route information of the first OSPF domain. This operation is based on the definition of the line C202 in the configuration database 110 of FIG. 19. Since the two interfaces 133 and 131 belong to the same first VRF network, the route information of the third OSPF domain and the route information of the first OSPF domain are related to an identical VRF network.

At step S632, the third OSPF processor 163 sends the route information of the third OSPF domain, i.e., the route information on the host 301, to the second OSPF processor 162. At step S633, the second OSPF processor 162 advertises the received route information as the route information of the second OSPF domain. This operation is based on the definition of the line C203 in the configuration database 110 of FIG. 19. Since the interface 133 belongs to the first VRF network and the interface 132 belongs to the second VRF network, i.e., the two interfaces 133 and 132 belong to different VRF networks, the route information of the third OSPF domain and the route information of the second OSPF domain are related to different VRF networks. The route information is, however, still advertised, based on the definition of the line C203 in the configuration database 110 to advertise route information of even an OSPF domain relating to a different VRF network.

At step S634, the first OSPF processor 161 sends the route information of the first OSPF domain, i.e., the route information on the external device and the subnetwork belonging to the first OSPF domain in the network 1001 and the route information on the primary server 201, to the third OSPF processor 163. At step S635, the third OSPF processor 163 advertises the received route information as the route information of the third OSPF domain. This operation is based on the definition of the line C207 in the configuration database 110 of FIG. 19. Since the route information of the third OSPF domain and the route information of the first OSPF domain are related to an identical VRF network due to the membership of the two interfaces 133 and 131 to the same first VRF network, the route information is advertised (vrf-check).

Since the interface 133 belongs to the first VRF network and the interface 132 belongs to the second VRF network, the route information of the third OSPF domain and the route information of the second OSPF domain are related to different VRF networks. The second OSPF processor 162 accordingly does not send the route information of the second OSPF domain, i.e., the route information on the external device and the subnetwork belonging to the second OSPF domain in the network 1002 and the route information on the primary server 201, to the third OSPF processor 163.

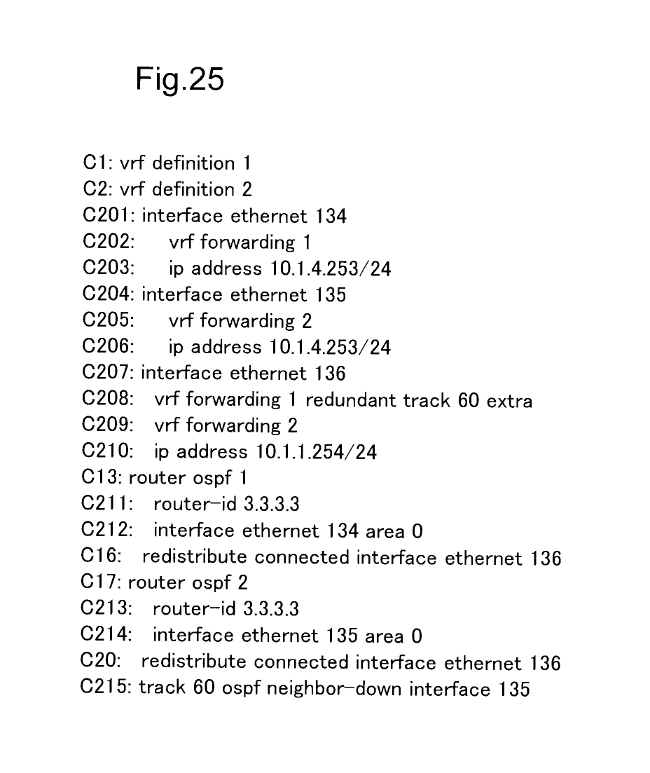

FIG. 25 is an explanatory diagrammatic representation of one example of configuration information used for defining the configuration of the network apparatus 102. This configuration information is stored in a configuration database 110 of the network apparatus 102. The difference from the configuration information of the first embodiment shown in FIG. 5 is deletion of the lines C3 to C12, C14, C15, C18, C19, and C21 and addition of lines C201 to C215. Otherwise the configuration information in the network apparatus 102 is similar to the configuration information of the first embodiment.

A line C201 defines the interface 134. Like the first embodiment, the interface 134 is an Ethernet (registered trademark) interface. The other interfaces 135 and 136 (described later) are also Ethernet (registered trademark) interfaces. A line C202 defines that the interface 134 belongs to the first VRF network. A line C203 defines an IP address and a subnet mask length of the interface 134. A line C204 defines the interface 135. A line C205 defines that the interface 135 belongs to the second VRF network. A line C206 defines an IP address and a subnet mask length of the interface 135. The same IP address is allocated to both the interfaces 134 and 135, because of the reason described in the first embodiment.

A line C207 defines the interface 136. A line C208 has definitions i) and j) given below:

i) On detection of an OSPF neighbor failure with the router 401 according to a status monitor rule 60, the membership of the interface 136 is to be changed over to the first VRF network; and

j) Even when the VRF network to which an input interface of a packet belongs is different from the VRF network to which an output interface of the packet belongs, the packet is not to be discarded but is to be forwarded.

A line C209 defines that the interface 136 belongs to the second VRF network. A line C210 defines an IP address and a subnet mask length of the interface 136.

A line C211 defines a router ID of a router belonging to the first OSPF domain. A line C212 defines operation of the interface 134 with an OSPF area number of ‘0’. A line C213 defines a router ID of a router belonging to the second OSPF domain. A line C214 defines operation of the interface 135 with the OSPF area number of ‘0’. A line C215 defines monitoring blockage of neighbor information of the routing protocol OSPF working at the interface 135. Namely the line C215 defines the status monitor rule 60 for an OSPF neighbor between the network apparatus 102 and a router included in the network 1002.

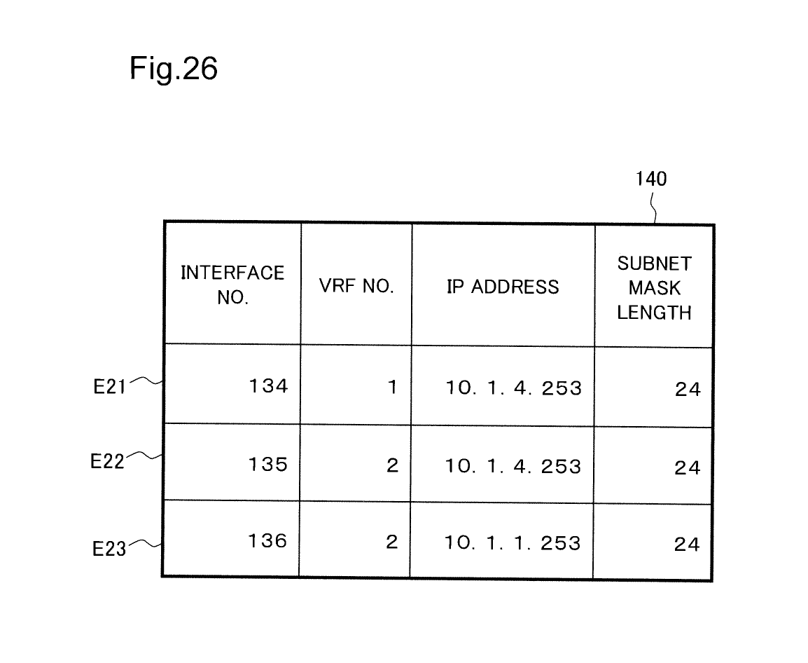

FIG. 26 is an explanatory diagrammatic representation of one example of the settings in an interface database 140 included in the network apparatus 102. The difference from the settings in the interface database 140 of the first embodiment shown in FIG. 6 is the registries of respective entries.

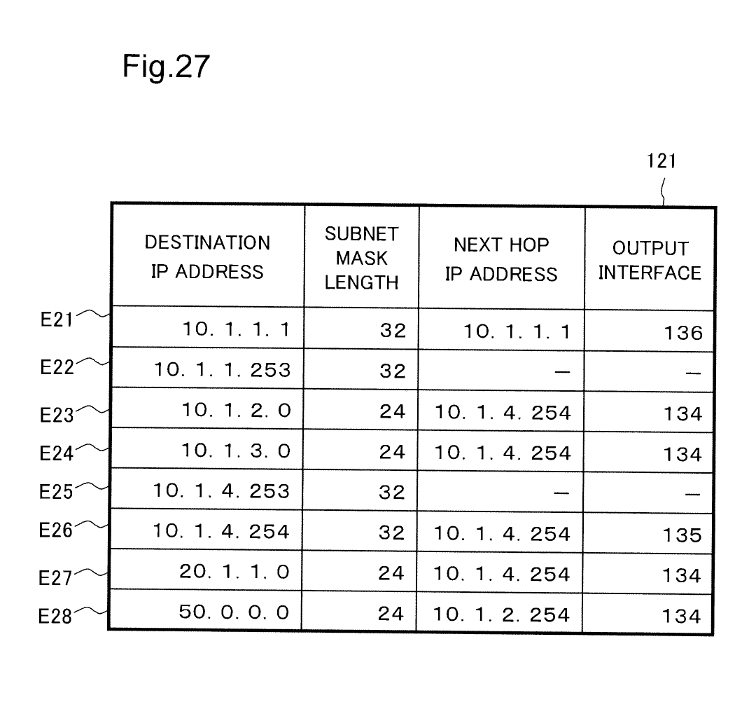

FIG. 27 is an explanatory diagrammatic representation of one example of the settings in the VRF1 routing table 121 of the network apparatus 102 based on the registries in the interface database 140 of FIG. 26. The difference from the settings in the VRF1 routing table 121 of the first embodiment shown in FIG. 8 is the registries of respective entries. The settings in the VRF1 routing table 121 of the network apparatus 102 are similar to those in the VRF1 routing table 121 of the network apparatus 101 shown in FIG. 22.

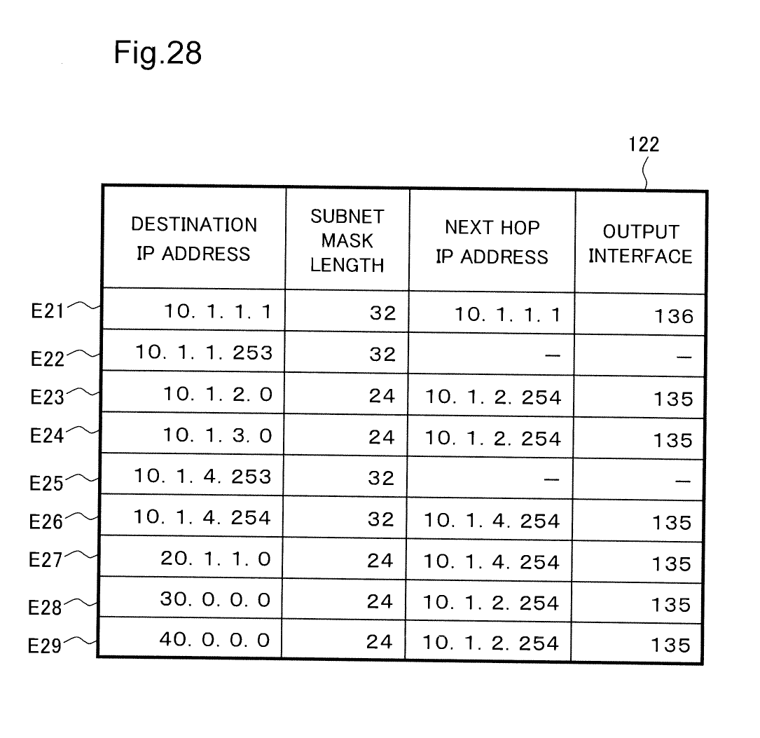

FIG. 28 is an explanatory diagrammatic representation of one example of the settings in the VRF2 routing table 122 of the network apparatus 102 based on the registries in the interface database 140 of FIG. 26. The difference from the settings in the VRF2 routing table 122 of the first embodiment shown in FIG. 9 is the registries of respective entries. The settings in the VRF2 routing table 122 of the network apparatus 102 are similar to those in the VRF2 routing table 122 of the network apparatus 101 shown in FIG. 23.

### (B-2) Operations Before Detection of Failure

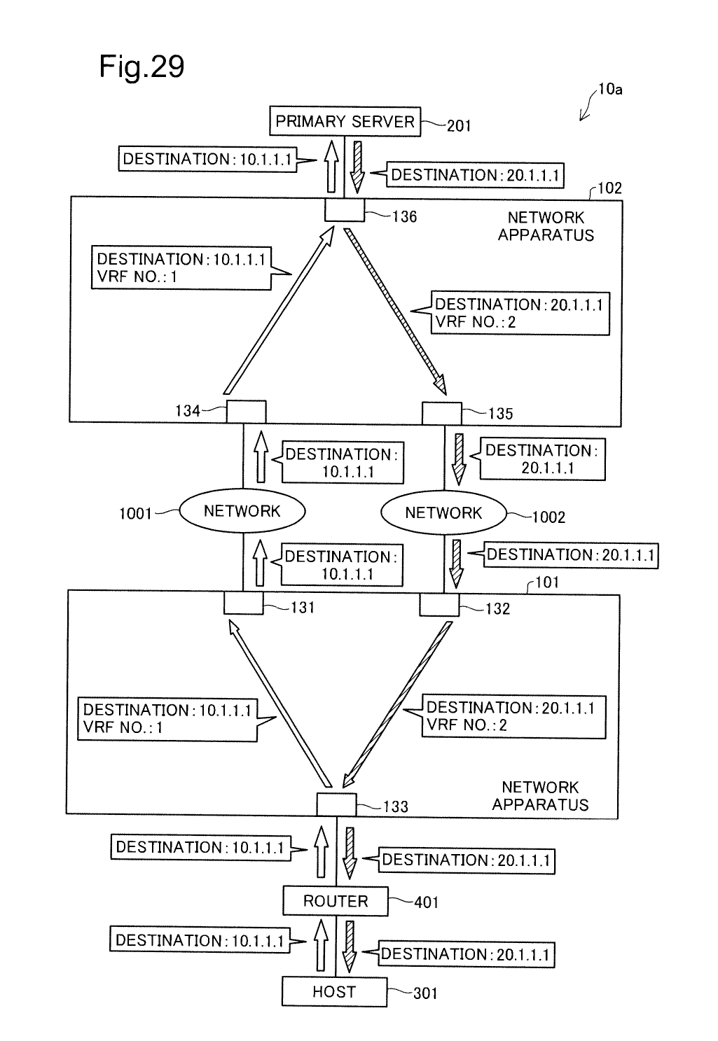

FIG. 29 is an explanatory diagrammatic representation of the operations of the network system 10a before the occurrence of a failure in an OSPF neighbor state of the network apparatus 101 with the router in the network 1001 as a monitor object. The host 301 sends a request packet with a destination IP address of ‘10.1.1.1’, in order to have access to the primary server 201. This request packet is sent to the router 401 having the IP address specified in the own default gateway field. The router 401 receives the request packet, reads the received request packet according to the OSPF protocol, and forwards the request packet to the interface 133 of the network apparatus 101, based on the route information stored in the router 401.

The network apparatus 101 receives the packet at the interface 133 and specifies a packet output interface by the packet forwarding process shown in FIG. 12 described above. Specifically the packet forwarding processor 150 obtains the registry of ‘1’ in the VRF number field of the matching entry E23 having the registry in the interface number field corresponding to the identifier ‘133’ of the packet input interface from the interface database 140 of the network apparatus 101 shown in FIG. 20 (step S12 in FIG. 12). The packet forwarding processor 150 searches the routing table specified by the obtained VRF number, i.e., the VRF1 routing table 121 shown in FIG. 22, and obtains the registry in the next hop IP address field and the registry in the output interface field of a matching entry (step S13 in FIG. 12). In the illustrated example of FIGS. 22 and 29, the packet forwarding processor 150 obtains the registry of ‘10.1.2.254’ in the next hot IP address field and the registry of ‘131’ in the output interface field of the matching entry E21 corresponding to the destination IP address ‘10.1.1.1’. Even when the packet input interface and the packet output interface belong to different VRF networks, the packet forwarding processor 150 still forwards the packet based on the definition of the line C201 shown in FIG. 19. The processing of step S14 shown in FIG. 12 is thus omitted in this processing flow.

The router in the network 1001 receives the packet, reads the received packet according to the OSPF protocol, and forwards the packet to the interface 134 of the network apparatus 102, based on the route information stored in the router.

The network apparatus 102 receives the packet at the interface 134 and specifies a packet output interface by the packet forwarding process shown in FIG. 12 described above. Specifically the packet forwarding processor 150 obtains the registry of ‘1’ in the VRF number field of the matching entry E21 having the registry in the interface number field corresponding to the identifier ‘134’ of the packet input interface from the interface database 140 of the network apparatus 102 shown in FIG. 26 (step S12 in FIG. 12). The packet forwarding processor 150 searches the routing table specified by the obtained VRF number, i.e., the VRF1 routing table 121 shown in FIG. 27, and obtains the registry in the next hop IP address field and the registry in the output interface field of a matching entry (step S13 in FIG. 12). In the illustrated example of FIGS. 27 and 29, the packet forwarding processor 150 obtains the registry of ‘10.1.1.1’ in the next hot IP address field and the registry of ‘136’ in the output interface field of the matching entry E21 corresponding to the destination IP address ‘10.1.1.1’. Even when the packet input interface and the packet output interface belong to different VRF networks, the packet forwarding processor 150 still forwards the packet based on the definition of the line C208 shown in FIG. 25. The processing of step S14 shown in FIG. 12 is thus omitted in this processing flow. The packet is then forwarded from the interface 136 of the network apparatus 102 to the primary server 201.

In this manner, the request packet sent from the host 301 is forwarded to the primary server 201. The primary server 201 provides a required service based on the request packet received from the host 301 and sends back a reply packet to the host 301. A destination IP address of the reply packet is the IP address ‘20.1.1.1’ of the host 301. This reply packet is sent to the interface 136 of the network apparatus 102 having the IP address specified in the own default gateway field.

The network apparatus 102 receives the packet at the interface 136 and specifies a packet output interface by the packet forwarding process shown in FIG. 12 described above. Specifically the packet forwarding processor 150 obtains the registry of ‘2’ in the VRF number field of the matching entry E23 having the registry in the interface number field corresponding to the identifier ‘136’ of the packet input interface from the interface database 140 of the network apparatus 102 shown in FIG. 26 (step S12 in FIG. 12). The packet forwarding processor 150 searches the routing table specified by the obtained VRF number, i.e., the VRF2 routing table 122 shown in FIG. 28, and obtains the registry in the next hop IP address field and the registry in the output interface field of a matching entry (step S13 in FIG. 12). In the illustrated example of FIGS. 28 and 29, the packet forwarding processor 150 obtains the registry of ‘10.1.4.254’ in the next hot IP address field and the registry of ‘135’ in the output interface field of the matching entry E27 corresponding to the destination IP address ‘20.1.1.1’. Even when the packet input interface and the packet output interface belong to different VRF networks, the packet forwarding processor 150 still forwards the packet based on the definition of the line C208 shown in FIG. 25. The processing of step S14 shown in FIG. 12 is thus omitted in this processing flow.

The router in the network 1002 receives the packet, reads the received packet according to the OSPF protocol, and forwards the packet to the interface 132 of the network apparatus 101, based on the route information stored in the router.

The network apparatus 101 receives the packet at the interface 132 and specifies a packet output interface by the packet forwarding process shown in FIG. 12 described above. Specifically the packet forwarding processor 150 obtains the registry of ‘2’ in the VRF number field of the matching entry E22 having the registry in the interface number field corresponding to the identifier ‘132’ of the packet input interface from the interface database 140 of the network apparatus 101 shown in FIG. 20 (step S12 in FIG. 12). The packet forwarding processor 150 searches the routing table specified by the obtained VRF number, i.e., the VRF2 routing table 122 shown in FIG. 23, and obtains the registry in the next hop IP address field and the registry in the output interface field of a matching entry (step S13 in FIG. 12). In the illustrated example of FIGS. 23 and 29, the packet forwarding processor 150 obtains the registry of ‘10.1.3.254’ in the next hot IP address field and the registry of ‘133’ in the output interface field of the matching entry E27 corresponding to the destination IP address ‘20.1.1.1’. Even when the packet input interface and the packet output interface belong to different VRF networks, the packet forwarding processor 150 still forwards the packet based on the definition of the line C201 shown in FIG. 19. The processing of step S14 shown in FIG. 12 is thus omitted in this processing flow.

The router 401 receives the packet, reads the received packet according to the OSPF protocol, and forwards the packet to the host 301, based on the route information stored in the router 401.

As described above, the packet forwarding processor 150 of the second embodiment forwards a received packet, even when the virtual network to which the packet source apparatus belongs is different from the virtual network to which the packet destination apparatus belongs. This characteristic enables packets to be forwarded by different routes for an upload path (i.e., communication path from the host 301 to the primary server 201) and for a download path (i.e., communication path from the primary server 201 to the host 301). This arrangement enhances the flexibility of packet forwarding in the network system.

### (B-3) Failover Process

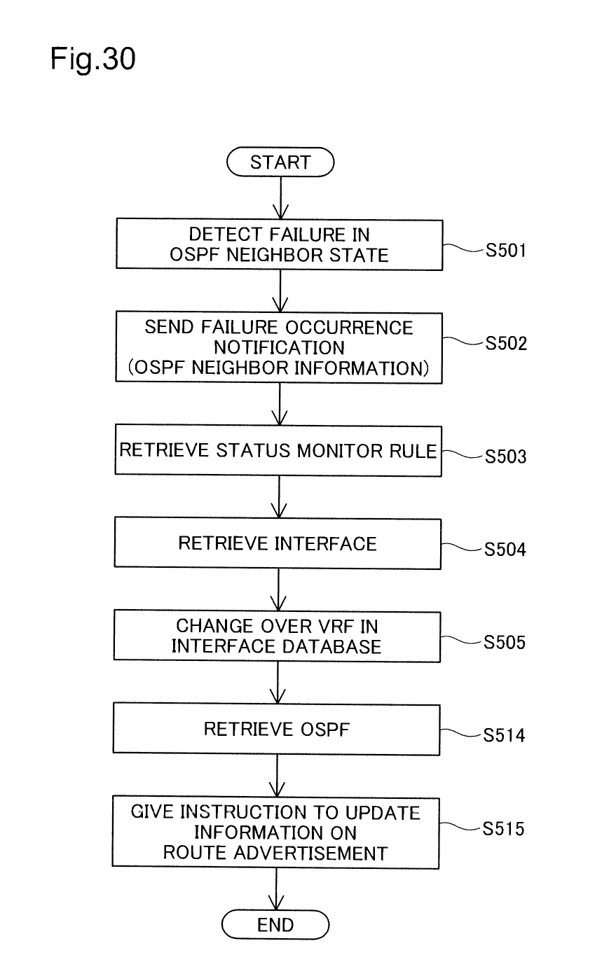

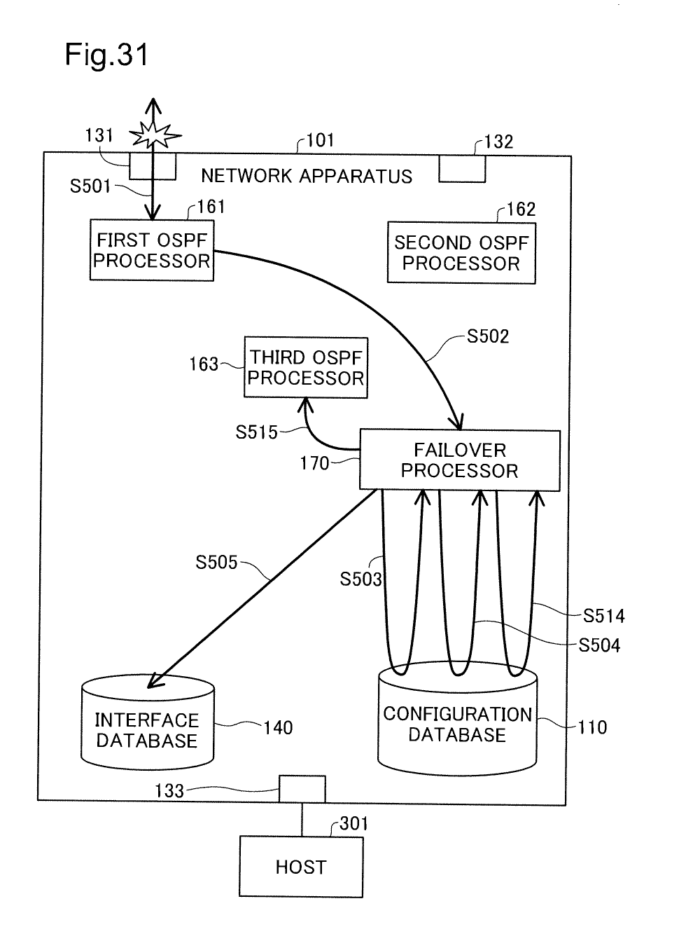

FIG. 30 is a flowchart showing a failover process performed in the second embodiment. The difference from the failover process of the first embodiment shown in FIG. 13 is additional steps S514 and S515. Otherwise the failover process of the second embodiment is similar to the failover process of the first embodiment. FIG. 31 is an explanatory diagrammatic representation of the operations of the network system 10a during the failover process of the second embodiment. The following describes a series of failover process performed by the first OSPF processor 161 of the network apparatus 101. The second OSPF processor 162 and the third OSPF processor 163 of the network apparatus 101 and the respective OSPF processors of the network apparatus 102 perform the similar series of failover process.

The first OSPF processor 161 of the network apparatus 101 detects the occurrence of a failure in the OSPF neighbor state with the router included in the network 1001 (step S501). On detection of the occurrence of a failure, the first OSPF processor 161 sends OSPF neighbor information as a failure occurrence notification to the failover processor 170 (step S502). The failover processor 170 retrieves an identification number ‘50’ of a status monitor rule from the definitions in the configuration database 110 of FIG. 19, based on the IP address of the router in the network 1001 specified by the OSPF neighbor information and the interface number ‘131’ of the interface connected to the router (step S503). Based on the identification number ‘50’ of the status monitor rule, the failover processor 170 retrieves an interface number ‘133’ and the specification of the status monitor rule 50 (representing a changeover of the membership of the interface 133 to the second VRF network on detection of a failure in the OSPF neighbor state with the router in the network 1001) defined on the line C201 in the configuration database 110 of FIG. 19 (step S504). The failover processor 170 updates the registry in the VRF number field of the interface database 140, based on the specification of the status monitor rule (step S505).

At step S514, the failover processor 170 retrieves an OSPF. Specifically the failover processor 170 retrieves an OSPF domain using the interface having the interface number retrieved at step S504 from the configuration database 110. In the illustrated example of FIG. 31, the interface number ‘133’ is retrieved at step S504, so that the third OSPF domain is retrieved as the OSPF domain using the interface ‘133’ at step S514. At step S515, the failover processor 170 gives an instruction to the OSPF processor for processing the OSPF domain retrieved at step S514, the third OSPF processor 163 in this example, to update information on route advertisement, which is used for advertising route information. In response to this instruction, the third OSPF processor 163 updates the route advertisement information.

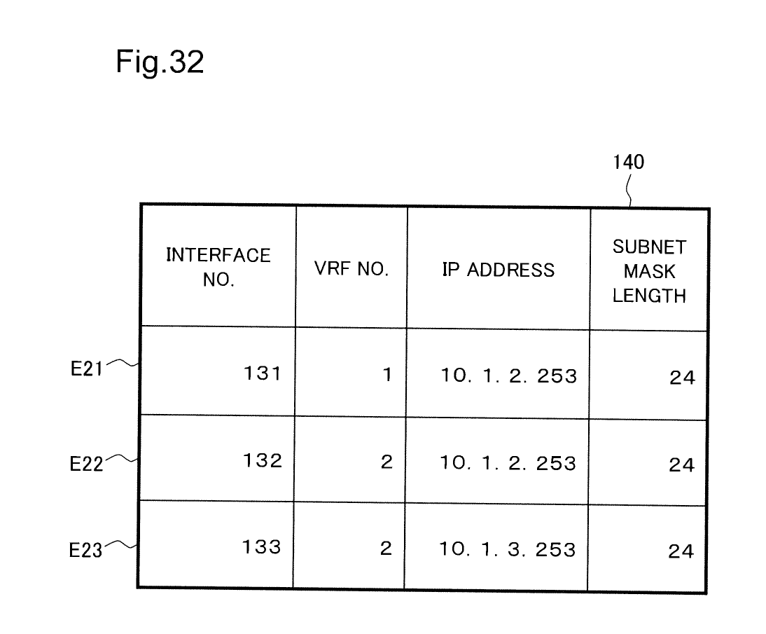

FIG. 32 is an explanatory diagrammatic representation of the registries in the interface database 140 of the network apparatus 101 after the update at step S505 in the failover process of FIG. 30. The difference from the registries in the interface database 140 shown in FIG. 20 before detection of a failure is that the registry in the VRF number field has been changed over to ‘2’ in the entry E23 having the registry of ‘133’ in the interface number field.

(B-4) Operations after Detection of Failure

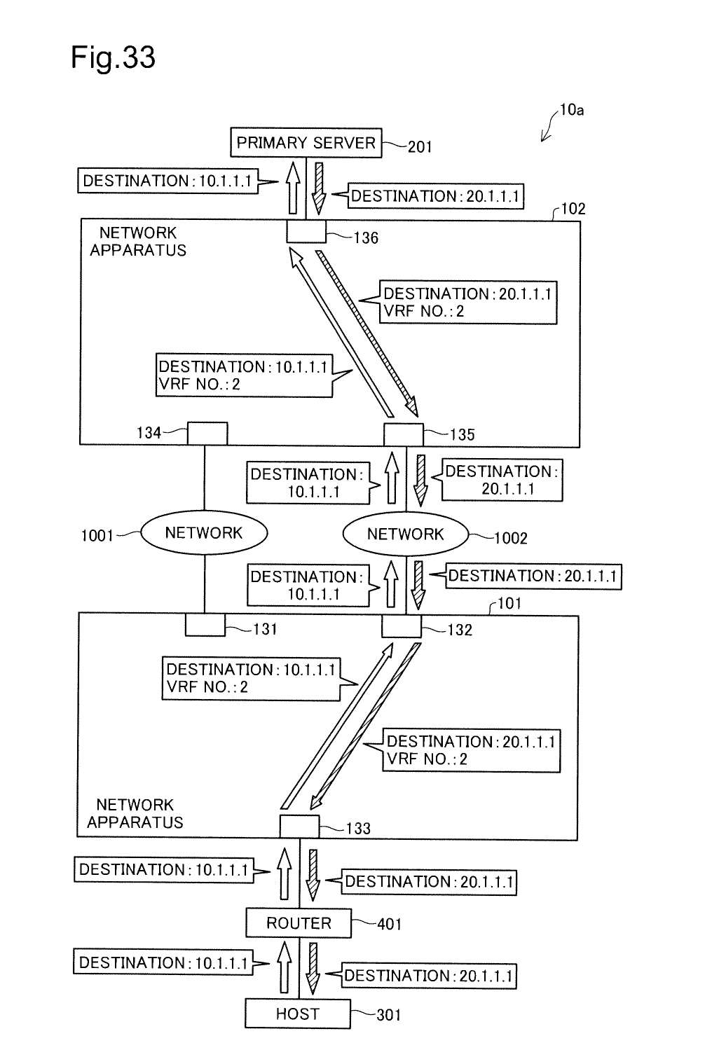

FIG. 33 is an explanatory diagrammatic representation of the operations of the network system 10a after the occurrence of a failure in the OSPF neighbor state with the router in the network 1001 as the monitor object. Compared with the state before the occurrence of a failure shown in FIG. 29, the network system 10a adopts a different route for packet forwarding from the host 301 to the primary server 201 but an identical route for packet forwarding from the primary server 201 to the host 301.

The host 301 sends a request packet with a destination IP address of ‘10.1.1.1’, in order to have access to the primary server 201. The router 401 receives the request packet and forwards the received request packet to the interface 133 of the network apparatus 101, based on the route information stored in the router 401.

The network apparatus 101 receives the packet at the interface 133 and specifies a packet output interface by the packet forwarding process shown in FIG. 12 described above. Specifically the packet forwarding processor 150 obtains the registry of ‘2’ in the VRF number field of the matching entry E23 having the registry in the interface number field corresponding to the identifier ‘133’ of the packet input interface from the interface database 140 of the network apparatus 101 shown in FIG. 32 (step S12 in FIG. 12). The packet forwarding processor 150 searches the routing table specified by the obtained VRF number, i.e., the VRF2 routing table 122 shown in FIG. 23, and obtains the registry in the next hop IP address field and the registry in the output interface field of a matching entry (step S13 in FIG. 12). In the illustrated example of FIGS. 23 and 33, the packet forwarding processor 150 obtains the registry of ‘10.1.2.254’ in the next hot IP address field and the registry of ‘13’ in the output interface field of the matching entry E21 corresponding to the destination IP address ‘10.1.1.1’.

The router in the network 1002 receives the packet and forwards the packet to the interface 135 of the network apparatus 102, based on the route information stored in the router.

The network apparatus 102 receives the packet at the interface 135 and specifies a packet output interface by the packet forwarding process shown in FIG. 12 described above. Specifically the packet forwarding processor 150 obtains the registry of ‘2’ in the VRF number field of the matching entry E22 having the registry in the interface number field corresponding to the identifier ‘135’ of the packet input interface from the interface database 140 of the network apparatus 102 shown in FIG. 26 (step S12 in FIG. 12). The packet forwarding processor 150 searches the routing table specified by the obtained VRF number, i.e., the VRF2 routing table 122 shown in FIG. 28, and obtains the registry in the next hop IP address field and the registry in the output interface field of a matching entry (step S13 in FIG. 12). In the illustrated example of FIGS. 28 and 33, the packet forwarding processor 150 obtains the registry of ‘10.1.1.1’ in the next hot IP address field and the registry of ‘136’ in the output interface field of the matching entry E21 corresponding to the destination IP address ‘10.1.1.1’. The packet is then forwarded from the interface 136 of the network apparatus 102 to the primary server 201.

Even after detection of the occurrence of a failure in the OSPF neighbor state with the router in the network 1001 by the network apparatus 101, communication between the host 301 and the primary server 201 is enabled by changing over the route for packet forwarding from the primary server 201 to the host 301.

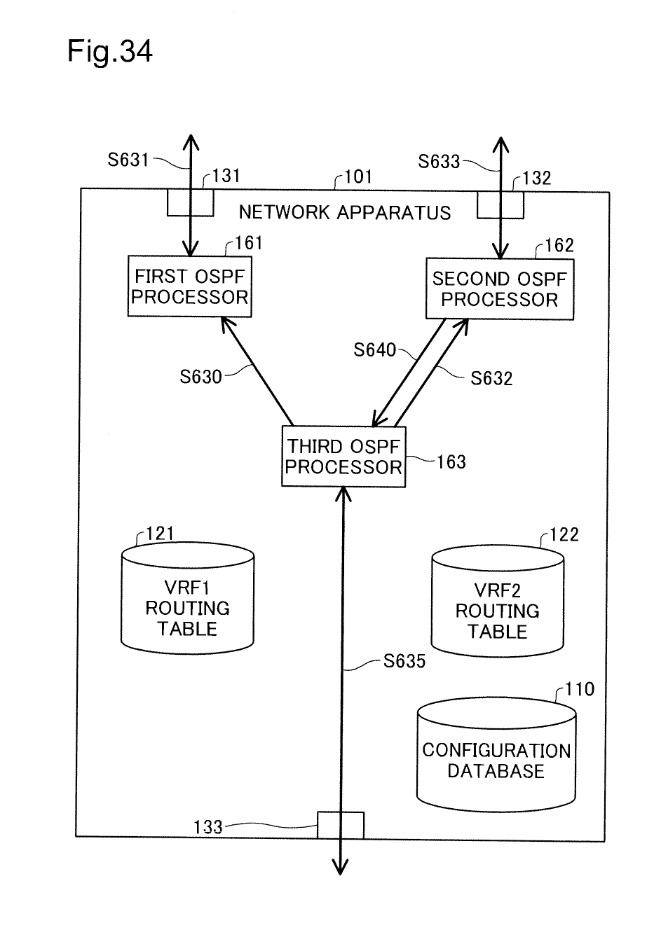

FIG. 34 is an explanatory diagrammatic representation of a processing flow for advertising the mutual route information by the first OSPF processor 161, the second OSPF processor 162, and the third OSPF processor 163 according to the OSPF protocol after the occurrence of a failure in the OSPF neighbor state with the router in the network 1001 as the monitor object. The difference from the processing flow before the occurrence of a failure shown in FIG. 24 is only deletion of step S634 and addition of step S640. Otherwise the processing flow after the occurrence of a failure shown in FIG. 34 is similar to the processing flow before the occurrence of a failure shown in FIG. 24. Such difference is ascribed to the update of the VRF number of the interface database 140 (and of the configuration database 110) to change over the membership of the interface 133 to the second VRF network by the failover process described above (step S505 in FIG. 30).

Based on the changeover of the VRF number of the interface 133 from ‘1’ to ‘2’, the first OSPF processor 161 does not send the route information of the first OSPF domain. At step S640, the second OSPF processor 162 sends the route information of the second OSPF domain, i.e., the route information on the external device and the subnetwork belonging to the second OSPF domain in the network 1002 and the route information on the primary server 201, to the third OSPF processor 163. At step S635, the third OSPF processor 163 advertises the received route information as the route information of the third OSPF domain.

As described above, the network system 10a of the second embodiment changes over the VRF network to which the interface belongs, on the occurrence of a failure in a line or at a node in the network system 10a, and advertises a new route according to the OSPF protocol to update the route information. In the configuration of the second embodiment, the network 1001 and the network 1002 in the network system 10a belong to the different VRF networks. Even when the network 1001 and the network 1002 have different network topologies, this arrangement of the second embodiment assures successful accesses in the communication between the host 301 and the primary server 201.

In the configuration of the network system 10a of the second embodiment, the first interface 134 of the first network relay apparatus (network apparatus 102) and the first interface 131 of the second network relay apparatus (network apparatus 101) connect with each other directly or indirectly via another network to establish the first virtual network. The second interface 135 of the first network relay apparatus (network apparatus 102) and the second interface 132 of the second network relay apparatus (network apparatus 101) connect with each other directly or indirectly via another network to establish the second virtual network. Namely there are redundant communication routes between the processing apparatus (primary server 201) and the client apparatus (host 301). The packet forwarding processor 150 uses the route information of a normal virtual network with no occurrence of a failure on the route out of the first virtual network and the second virtual network to forward a received packet to a packet destination apparatus. This configuration of the second embodiment has the similar effects to those of the first embodiment.

### C. Modifications

The invention is not limited to any of the embodiments and their applications discussed above but may be actualized in diversity of other embodiments and applications within the scope of the invention. Some examples of possible modification are given below.

### C1. Modified Example 1

The embodiments describe the configuration of causing the network apparatus to monitor the OSPF neighbor state. Such configuration is, however, neither essential nor restrictive, but any other suitable configuration may be adopted instead. One modified configuration of the first embodiment may monitor the loading state of the processing apparatuses (primary server 201 and backup server 202) and, when the load of one processing apparatus currently working as the primary server exceeds a preset load level, perform the failover process to change over the communication route to the backup route (i.e., change over the working server to the other processing apparatus as the backup server).

Another modified configuration of the first embodiment may monitor the network load from the network apparatus to the processing apparatus and change over the communication route to the backup route according to the network load.

In one application of the first embodiment may perform the failover process to change over the communication route to the backup route (i.e., change over the working server to the backup server) on every occasion of replacement of the processing apparatus currently working as the primary server.

### C2. Modified Example 2

The embodiments describe monitoring the OSPF neighbor state as one example of the monitor object and the monitoring method for detecting the occurrence of a failure at a node or in a line in the network system. Monitoring the OSPF neighbor state is, however, neither essential nor restrictive, but any other suitable monitor object and monitoring method may be adopted instead. For example, the accessibility of communication to the server may be set as the monitor object. In another example, the status of any arbitrary interface may be set as the monitor object.

In one modified configuration, an external device other than the network apparatus (for example, a management terminal) may monitor the OSPF neighbor state and, on detection of a failure, notify the network apparatus of the occurrence of the failure.

The external device other than the network apparatus (for example, the management terminal) may monitor the OSPF neighbor state to detect a failure and display the occurrence of a failure. The network administrator may give an operation command to perform the failover process.

### C3. Modified Example 3

In the configuration of the first embodiment, the two routers (routers 401 and 402) included in the network system are physically separate apparatuses. The two routers are not necessarily constructed as physically separate apparatuses. For example, the routers 401 and 402 may be designed physically as one router structure with the VRF functions to logically behave as two separate routers.

Similarly the two servers (primary server 201 and backup server 202) included, in the network system are not necessarily constructed as physically separate apparatuses. For example, the primary server 201 and the backup server 202 may be implemented as logical servers. Similarly the interface 131 and the interface 132 may be implemented as logical interfaces.

The apparatuses constituting the two networks (networks 1001 and 1002) in the network system are not necessarily constructed as physically separate apparatuses. For example, part or all of the apparatuses constituting the two networks may be designed physically as one identical apparatus structure.

### C4. Modified Example 4

The above embodiments use the OSPF protocol. The routing protocol used for route control between network apparatuses is, however, not restricted to the OSPF protocol but may be any other suitable protocol or any combination of any multiple different protocols. In one modified configuration of the second embodiment, the OSPF protocol may be adopted for route control with the network 1001, while the BGP protocol may be adopted for route control with the network 1002. There is no restriction on the combination of multiple routing protocols.

The above embodiments use IPv4 (Internet Protocol version 4) as the layer 3 protocol. The layer 3 protocol is, however, not restricted to IPv4 but may be any other suitable protocol, for example, IPv6 (Internet Protocol version 6).

### C5. Modified Example 5

In the network apparatus of the above embodiments, the first OSPF processor generates and stores the route information as the first VRF routing table, and the second OSPF processor generates and stores the route information as the second VRF routing table. One of the two routing tables is used for packet forwarding. The route information used for packet forwarding is, however, not limited to the route information generated by one OSPF processor. For example, the first OSPF processor may generate and store the route information as the first VRF routing table and as the second VRF routing table, and the second OSPF processor may separately generate and store the route information as the first VRF routing table and as the second VRF routing table. A multi-path configuration with an output interface belonging to the first VRF network (interface 131) and an output interface belonging to the second VRF network (interface 132) may be adopted for route control to an identical destination.

### C6. Modified Example 6

For the simplicity of explanation, the network apparatus has the two VRFs in the embodiments described above. The number of VRFs implemented on the network apparatus may be determined arbitrarily. A VRF attributes-free global network may be implemented on the network apparatus. In this case, the global network may be regarded as one type of VRF without the VRF attributes.

### C7. Modified Example 7

The exemplary configurations of the network systems are described in the above embodiments. The configuration of the network system is, however, not restricted to these embodiments but may be changed and modified arbitrarily within the scope of the invention. The number of servers and the number of hosts included in the network system may be determined arbitrarily. Any of the servers and the hosts may be connected indirectly to the network apparatus via another network apparatus. As long as the settings in the server represent one identical IP address, different IP addresses may be allocated to the respective apparatuses in the network.

The above embodiments describe the network apparatuses belonging to the OSPF domains. The network apparatuses belonging to the OSPF domains may have any arbitrary configuration. For example, in the configuration of the first embodiment, the router 401 is the network apparatus belonging to the first OSPF domain other than the network apparatus 100. The membership of the router 401 to the first OSPF domain is, however, neither essential nor restrictive. Another apparatus may be added to the membership to the first OSPF domain or some apparatus may be omitted from the membership to the first OSPF domain.

### C8. Modified Example 8

The exemplary structures of the network apparatuses are described in the above embodiments. The structure of the network apparatus is, however, not restricted to these embodiments but may be changed and modified arbitrarily within the scope of the invention. For example, logical interfaces multiplexed on a VLAN (Virtual Local Area Network) may be provided as the interfaces of the network apparatus. In another example, link aggregations, tunnel interfaces, MPLS (Multi-Protocol Label Switching)-based LSPs (Label Switched Paths), and other virtual interfaces may be provided as the interfaces of the network apparatus.

The exemplary structures of the tables included in the network apparatus are described in the above embodiments. The fields included in the tables may be determined arbitrarily within the scope of the invention. For example, the tables may be structured to have other adequate fields, in addition to or in place of those described in the embodiments. The respective tables may be formed in the direct map format.

### C9. Modified Example 9

The embodiments and their modified examples discussed above are to be considered in all aspects as illustrative and not restrictive. There may be many other modifications, changes, and alterations without departing from the scope or spirit of the main characteristics of the present invention. Part or all of the structures and the functions actualized by the hardware devices, modules or units in the above embodiments may be accomplished by the software configuration. Part or all of the functions implemented by the software modules in the above embodiments may be accomplished by the hardware configuration. All changes within the meaning and range of equivalency of the claims are intended to be embraced therein. The scope and spirit of the present invention are indicated by the appended claims, rather than by the foregoing description.

What is claimed is:

1. A network relay apparatus connected directly or indirectly to a first processing apparatus, a second processing apparatus, and a client apparatus, the network relay apparatus being configured to relay packet communication between the respective apparatuses, wherein one identical address is set in both the first processing apparatus and the second processing apparatus, and the client apparatus uses the first processing apparatus and the second processing apparatus, the network relay apparatus comprising:
a first route information storage configured to store route information of a first virtual network to which the first processing apparatus belongs;
a second route information storage configured to store route information of a second virtual network to which the second processing apparatus belongs;
a route information advertiser configured to receive advertisement for route information on the first virtual network and store the received route information into the first route information storage, while receiving advertisement for route information on the second virtual network and storing the received route information into the second route information storage;
a state detector configured to detect a state of the first virtual network and a state of the second virtual network; and
a packet forwarding processor configured to forward a packet, which is received from the client apparatus and has the identical address as a destination, to the first processing apparatus or the second processing apparatus, based on route information of one of the first and second virtual networks specified according to the detected states of the first and second virtual networks.

2. The network relay apparatus according to claim 1, wherein the state detector includes:
a first state detector configured to detect a failure on a route in the first virtual network; and
a second state detector configured to detect a failure on a route in the second virtual network,
the network relay apparatus further comprising:
a VRF definition information storage configured to store VRF definition information for defining which of the first virtual network and the second virtual network each of interfaces respectively connected to the first processing apparatus, the second processing apparatus, and the client apparatus belongs to, and
a failover processor configured to update at least one of the route information and the VRF definition information, based on occurrence or non-occurrence of a failure detected by the first state detector or the second state detector,
wherein on reception of a packet, the packet forwarding processor identifies a virtual network to which a packet input interface of receiving the packet belongs according to the VRF definition information, searches a route based on route information on the identified virtual network, and forwards the received packet via the searched route.

3. The network relay apparatus in accordance with claim 2, wherein the VRF definition information defines in advance that the interface connected to the first processing apparatus and the interface connected to the client apparatus belong to the first virtual network, and
the interface connected to the second processing apparatus belongs to the second virtual network, and
on detection of a failure by the first state detector, the failover processor updates the VRF definition information to change over membership of the interface connected to the client apparatus to the second virtual network.

4. The network relay apparatus according to claims 2, wherein on reception of a packet, the packet forwarding processor compares the virtual network to which the packet input interface belongs with a virtual network to which a packet output interface connected to an apparatus as a destination of the received packet belongs, and
when the virtual networks match each other, the packet forwarding processor forwards the received packet, when the virtual networks do not match each other, discarding the received packet without forwarding.

5. A network system, comprising:
a first processing apparatus arranged to belong to a first virtual network;
a second processing apparatus arranged to belong to a second virtual network;
a client apparatus configured to use the first processing apparatus or the second processing apparatus; and
a network relay apparatus connected directly or indirectly to the first processing apparatus, the second processing apparatus, and the client apparatus and configured to relay packet communication between the respective apparatuses,
wherein the first processing apparatus and the second processing apparatus have one identical address, and
the network relay apparatus comprises:
a first route information storage configured to store route information of the first virtual network;
a second route information storage configured to store route information of the second virtual network;
a route information advertiser configured to receive advertisement for route information on the first virtual network and store the received route information into the first route information storage, while receiving advertisement for route information on the second virtual network and storing the received route information into the second route information storage;
a state detector configured to detect a state of the first virtual network and a state of the second virtual network; and
a packet forwarding processor configured to forward a packet, which is received from the client apparatus and has the identical address as a destination, to the first processing apparatus or the second processing apparatus, based on route information of one of the first and second virtual networks specified according to the detected states of the first and second virtual networks.

6. A control method for a network relay apparatus, the network relay apparatus being connected directly or indirectly to a first processing apparatus, a second processing apparatus, and a client apparatus, the network relay apparatus being configured to relay packet communication between the respective apparatuses, wherein one identical address is set in both the first processing apparatus and the second processing apparatus, and the client apparatus uses the first processing apparatus and the second processing apparatus, the control method comprising the steps of;
(a) receiving advertisement for route information on the first virtual network to which the first processing apparatus belongs and storing the received route information;
(b) receiving advertisement for route information on the second virtual network to which the second processing apparatus belongs and storing the received route information;
(c) detecting a state of the first virtual network and a state of the second virtual network; and
(d) forwarding a packet, which is received from the client apparatus and has the identical address as a destination, to the first processing apparatus or the second processing apparatus, based on route information of one of the first and second virtual networks specified according to the detected states of the first and second virtual networks.

7. A network system, comprising:
a first network relay apparatus connected to a processing apparatus; and
a second network relay apparatus connected to a client apparatus using the processing apparatus,
wherein a first interface of the first network relay apparatus and a first interface of the second network relay apparatus connect with each other directly or indirectly via another network to establish a first virtual network, and
a second interface of the first network relay apparatus and a second interface of the second network relay apparatus connect with each other directly or indirectly via another network to establish a second virtual network,
each of the first network relay apparatus and the second network relay apparatus comprising:
a first route information storage configured to store route information of the first virtual network;
a second route information storage configured to store route information of the second virtual network;
a route information advertiser configured to receive advertisement for route information on the first virtual network and store the received route information into the first route information storage, while receiving advertisement for route information on the second virtual network and storing the received route information into the second route information storage; and
a packet forwarding processor configured to forward a received packet to a packet destination apparatus, based on route information of one of the first and second virtual networks specified according to states of the first and second virtual networks.

8. The network system according to claim 7, wherein the first network relay apparatus further includes a VRF definition information storage configured to store VRF definition information for defining which of the first virtual network and the second virtual network the processing apparatus belongs to,
the second network relay apparatus further includes a VRF definition information storage configured to store VRF definition information for defining which of the first virtual network and the second virtual network the client apparatus belongs to,
on reception of a packet, the packet forwarding processor of the first network relay apparatus or the packet forwarding processor of the second network relay apparatus compares a virtual network to which a packet input interface of receiving the packet belongs with a virtual network to which a packet output interface connected to an apparatus as a destination of the received packet belongs, and forwards the received packet, irrespective of matching or mismatching of the virtual networks.
